(19) United States
(12) Patent Application Publication
(10) Pub. No.: US 2019/0241749 A1
(43) Pub. Date: Aug. 8, 2019

(54) METHOD FOR PRODUCING AQUEOUS SILICONE RESIN EMULSION FOR PREPARING COATING COMPOSITION

(71) Applicant: NIPPON PAINT INDUSTRIAL COATINGS CO., LTD., Tokyo (JP)

(72) Inventors: Yuji ITO, Osaka (JP); Takehiro OJIMA, Osaka (JP); Masahiko HARADA, Osaka (JP); Hiroki ANDO, Osaka (JP)

(73) Assignee: NIPPON PAINT INDUSTRIAL COATINGS CO., LTD., Tokyo (JP)

(21) Appl. No.: 16/266,435

(22) Filed: Feb. 4, 2019

(30) Foreign Application Priority Data
Feb. 6, 2018 (JP) 2018-018963
Feb. 6, 2018 (JP) 2018-018965
Feb. 6, 2018 (JP) 2018-018967

(51) Int. Cl. C09D 5/02; C09D 183/04; C09D 7/40; C09D 7/61

(52) U.S. Cl. CPC C09D 5/022; C09D 5/027; C09D 183/04; C08K 3/36; C09D 7/68; C09D 7/61; C09D 7/67

(57) ABSTRACT

The invention provides an aqueous silicone resin emulsion for preparing a coating composition, an aqueous coating composition using the same, and a method for producing an aqueous clear coating composition.

### BACKGROUND OF THE INVENTION

### (1) Field of the Invention

This application has priority rights of Japanese patent application Nos. 2018-018963, 2018-018965 and 2018-018967, filed Feb. 6, 2018, which are herein incorporated by references.

The present invention relates to a method for producing an aqueous silicone resin emulsion for preparing a coating composition.

### (2) Description of Related Art

Various coating compositions for use in aerospace painting are applied onto walls of buildings including houses and buildings for the purpose of maintaining the quality and appearance of wall surfaces under exposure to the elements and direct exposure to sunlight. Such a coating composition is required to have performances such as weatherability against the elements, water resistance, light resistance, color fastness, and adhesiveness to substrates. In addition, in the field of coating composition, switching to aqueous coating compositions is going on in recent years from the viewpoints of environmental burden, safety in painting work and sanitation. As coating compositions for use in aerospace painting, coating compositions containing an acrylic resin emulsion are widely used.

In the case where long-term weatherability and durability are required, coating compositions containing an acrylic silicone resin emulsion which is silicone-modified with a modifier having a specific silicone structure are used. In recent years, further improvement in performance has been demanded, and there is a need for a coating composition that exhibits superior weatherability and durability, which can maintain its appearance for a long period even under, especially, harsh outdoor environments.

As an example of means for improving performance such as weatherability, there is contemplated means of increasing the proportion of the silicone structural component contained in an acrylic silicone resin based emulsion. For example, JP-A-2001-172340 discloses a resin composition comprising a polyalkoxypolysiloxane-based compound (A) obtained by reacting a polyalkoxypolysiloxane (a1) with a polymer compound (a2) having a functional group capable of reacting with the siloxane, a polymer (B′) of a radically polymerizable unsaturated monomer (B), and a silicate oligomer (C). This resin composition is described to be capable of improving the weatherability of a coating film.

As another example of means for improving performance such as weatherability, there is contemplated means of preparing a silicone resin emulsion in which silicone resin is dispersed in an aqueous medium. For example, JP-A-2014-031413 discloses a method for producing a silicone resin emulsion containing no organic solvents characterized by (i) replacing a solvent component of an organic solvent solution of a silicone resin (A) synthesized in an organic solvent with a nonionic emulsifier (B), thereby forming a nonionic emulsifier solution of the silicone resin (A); (ii) adding water to the nonionic emulsifier solution of the silicone resin (A); and (iii) emulsifying.

JP-A-2003-213005 discloses a method for producing an organopolysiloxane emulsion in which a dispersion containing an organopolysiloxane, a surfactant and water as main components is separated into at least two passages and then the portions of the dispersion are jet-impinged, thereby being micronized, wherein the flows of the dispersion are jet-impinged at a flow rate of 400 m/s or more.

### SUMMARY OF THE INVENTION

In the method described in JP-A-2001-172340, since a radically polymerizable unsaturated monomer is used in addition to the silicone structural component, the range in which the proportion of the silicone structural component can be increased is naturally limited. On the other hand, since the method disclosed in JP-A-2014-031413 is a method of dispersing a silicone resin itself, it is advantageous in that an emulsion with an increased content of the silicone resin can be obtained. However, according to the investigation by the present inventors, the method disclosed in JP-A-2014-031413 sometimes leads to cases where the storage stability, etc. of an emulsion is poor depending on the structure of a silicone resin.

A challenge of the present invention is to solve the problems of the above-described conventional technologies. More specifically, it is a challenge of the present invention to provide an aqueous silicone resin emulsion for preparing a coating composition and a process for producing a coating composition containing the same.

For solving the above-described problems, the present invention provides the following embodiments.
[1] A method for producing an aqueous silicone resin emulsion for preparing a coating composition, comprising the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture, and

a desolventization step of at least partially removing the organic solvent (B) from the resulting emulsified mixture, thereby obtaining an aqueous silicone resin emulsion for preparing a coating composition,

wherein the silicone resin (A) comprises a branched organopolysiloxane (A1) having a weight average molecular weight within a range of 5,000 to 300,000,

the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water,

a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and a mass ratio (A):(B) of the silicone resin (A) and the organic solvent (B) contained in the emulsified mixture satisfies the relationship of (A):(B)=1:2 to 1:0.2.
[2] A method for preparing an aqueous coating composition comprising a silicone resin emulsion, comprising the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,

a desolventization step of at least partially removing the organic solvent (B) from the resulting emulsified mixture, thereby obtaining a silicone resin emulsion, and

a step of preparing an aqueous coating composition comprising the resulting silicone resin emulsion,

wherein the silicone resin (A) comprises

a branched organopolysiloxane (A1) having a weight average molecular weight within a range of 5,000 to 100,000, and

a linear organopolysiloxane (A2) having a weight average molecular weight within a range of 1,000 to 30,000,

a mass ratio of the branched organopolysiloxane (A1) and the linear organopolysiloxane (A2) contained in the aqueous coating composition is within a range of (A1)=(A2)=98:2 to 40:60,

the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water,

a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and a mass ratio (A):(B) of the silicone resin (A) and the organic solvent (B) contained in the emulsified mixture satisfies the relationship of (A):(B)=1:2 to 1:0.2.
[3] A method for preparing an aqueous coating composition comprising a silicone resin emulsion, comprising the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,

a desolventization step of at least partially removing the organic solvent (B) from the resulting emulsified mixture, thereby obtaining a silicone resin emulsion, and

a step of mixing the resulting silicone resin emulsion and an emulsion prepared in advance and comprising a linear organopolysiloxane (A2) having a weight average molecular weight within a range of 1,000 to 30,000, thereby preparing an aqueous coating composition,

wherein the silicone resin (A) comprises a branched organopolysiloxane (A1) having a weight average molecular weight within a range of 5,000 to 100,000, and

a mass ratio of the branched organopolysiloxane (A1) and the linear organopolysiloxane (A2) contained in the aqueous coating composition is within a range of (A1):(A2)=98:2 to 40:60,

the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water,

a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and a mass ratio (A):(B) of the silicone resin (A) and the organic solvent (B) contained in the emulsified mixture satisfies the relationship of (A):(B)=1:2 to 1:0.2.
[4] A method for preparing an aqueous clear coating composition comprising a silicone resin emulsion, comprising the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,

a desolventization step of at least partially removing the organic solvent (B) from the resulting emulsified mixture, thereby obtaining a silicone resin emulsion, and

a step of mixing the resulting silicone resin emulsion and an inorganic oxide fine particle (D), thereby preparing an aqueous clear coating composition,

wherein the silicone resin (A) comprises a branched organopolysiloxane (A1) having a weight average molecular weight within a range of 5,000 to 100,000,

the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water,

a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and a mass ratio (A):(B) of the silicone resin (A) and the organic solvent (B) contained in the emulsified mixture satisfies the relationship of (A):(B)=1:2 to 1:0.2,

the inorganic oxide fine particle (D) has an average particle diameter within a range of 20 to 300 nm.
[5] A method for preparing an aqueous clear coating composition comprising a silicone resin emulsion, comprising the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,

a desolventization step of at least partially removing the organic solvent (B) from the resulting emulsified mixture, thereby obtaining a silicone resin emulsion, and

a step of mixing the resulting silicone resin emulsion, an inorganic oxide fine particle (D) and an emulsion prepared in advance and comprising a linear organopolysiloxane (A2) having a weight average molecular weight within a range of 1,000 to 30,000, thereby preparing an aqueous clear coating composition,

wherein the silicone resin (A) comprises a branched organopolysiloxane (A1) having a weight average molecular weight within a range of 5,000 to 100,000, and

a mass ratio of the branched organopolysiloxane (A1) and the linear organopolysiloxane (A2) contained in the aqueous clear coating composition is within a range of (A1):(A2)=98:2 to 40:60,

the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water,

a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and a mass ratio (A):(B) of the silicone resin (A) and the organic solvent (B) contained in the emulsified mixture satisfies the relationship of (A):(B)=1:2 to 1:0.2,

the inorganic oxide fine particle (D) has an average particle diameter within a range of 20 to 300 nm.

According to the production method of the present invention, it is possible to produce a silicone resin emulsion containing a branched organopolysiloxane (A1), wherein the silicone resin emulsion is a fine particle and is superior in storage stability. By the production method of the present invention, an aqueous silicone resin emulsion for preparing a coating composition can be produced.

In addition, according to the production method of the present invention, an aqueous coating composition containing a silicone resin emulsion containing a branched organopolysiloxane (A1) and a linear organopolysiloxane (A2) can be produced. The aqueous coating composition is advantageous in that it can form a coating film superior in weatherability and durability.

Furthermore, according to the production method of the present invention, it is possible to produce a silicone resin emulsion containing a branched organopolysiloxane (A1), wherein the silicone resin emulsion is fine particles and is superior in storage stability. By the production method of the present invention, an aqueous clear coating composition containing a silicone resin emulsion and an inorganic oxide fine particle can be produced. The above-mentioned aqueous clear coating composition is advantageous in that it can maintain an ultraviolet ray blocking property and visible light transparency for a long period of time.

### DETAILED DESCRIPTION OF PREFERRED EMBODIMENTS

First, the process leading to the present invention will be described. As described in JP-A-2014-031413 and JP-A-2003-213005, various studies have been conducted on the preparation of silicone resin emulsions, etc. On the other hand, as a result of investigations by the present inventors, these conventional techniques were found to have the following problems.

The production method described in JP-A-2014-031413 is a production method characterized in that a solvent component in an organic solvent solution of a silicone resin synthesized in an organic solvent is replaced by a nonionic emulsifier to form a nonionic emulsifier solution and then water is added to the resulting solution to emulsify it. In this method, however, experiments conducted by the present inventors have revealed that emulsions may have an increased particle size and the storage stability thereof may be poor depending on the type of silicone resin.

The production method described in JP-A-2003-213005 is a production method characterized in that portions of a dispersion containing an organopolysiloxane, a surfactant and water are jet-impinged by using a jet-impingement type emulsifier, thereby being micronized. Since this method includes a step of jet-impingement, when the viscosity of the dispersion is high, that is, when the viscosity of the organopolysiloxane is high, there is a possibility that it is difficult to perform jet-impingement.

The present inventors aimed to develop a method by which an emulsion having a sufficiently fine particle diameter and being superior in storage stability, etc. can be prepared even in the case of using, for example, a silicone resin with a high viscosity. Then, they found that performing emulsification with a mixture containing a silicone resin and an organic solvent, followed by removing the organic solvent makes it possible to prepare a silicone resin emulsion having a sufficiently fine particle diameter and being superior in storage stability even in the case of using a silicone resin with a high viscosity. Furthermore, using this silicone resin emulsion, an aqueous coating composition and an aqueous clear coating composition were prepared, leading to the completion of the present invention. Hereinafter, the production method of the present invention will be described.

The above-mentioned method for producing an aqueous silicone resin emulsion for preparing a coating composition includes the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture, and

a step of at least partially removing the organic solvent (B) from the resulting emulsified mixture, thereby obtaining an aqueous silicone resin emulsion for preparing a coating composition.

One embodiment of a method for preparing an aqueous coating composition containing a silicone resin emulsion (hereinafter referred to as “the First Embodiment”) includes the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture, and

a desolventization step of at least partially removing the organic solvent (B) from the resulting emulsified mixture, thereby obtaining a silicone resin emulsion, and

a step of preparing an aqueous coating composition comprising the resulting silicone resin emulsion. In this embodiment, the silicone resin (A) to be used for the preparation of the emulsified mixture contains:

a branched organopolysiloxane (A1) having a weight average molecular weight within a range of 5,000 to 100,000, and

a linear organopolysiloxane (A2) having a weight average molecular weight in a range of 1,000 to 30,000.

Another embodiment of a method for preparing an aqueous coating composition containing a silicone resin emulsion (hereinafter referred to as “the Second Embodiment”) includes the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,

a desolventization step of at least partially removing the organic solvent (B) from the resulting emulsified mixture, thereby obtaining a silicone resin emulsion, and

a step of mixing the resulting silicone resin emulsion and an emulsion prepared in advance and comprising a linear organopolysiloxane (A2) having a weight average molecular weight within a range of 1,000 to 30,000, thereby preparing an aqueous coating composition.

In this embodiment, the silicone resin (A) to be used for the preparation of the emulsified mixture contains a branched organopolysiloxane (A1) having a weight average molecular weight in a range of 5,000 to 100,000.

One embodiment of a method for preparing an aqueous clear coating composition containing a silicone resin emulsion (hereinafter referred to as “the First Embodiment”) includes the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture, and

a desolventization step of at least partially removing the organic solvent (B) from the resulting emulsified mixture, thereby obtaining a silicone resin emulsion, and

a step of mixing the resulting silicone resin emulsion and an inorganic oxide fine particle (D), thereby preparing an aqueous clear coating composition.

In the First Embodiment, the silicone resin (A) to be used for the preparation of the emulsified mixture preferably comprises a linear organopolysiloxane (A2) having a weight average molecular weight within a range of 1,000 to 30,000 in addition to the branched organopolysiloxane (A1).

Another embodiment of a method for preparing an aqueous clear coating composition containing a silicone resin emulsion (hereinafter referred to as “second embodiment”) includes the following steps:

an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,

a desolventization step of at least partially removing the organic solvent (B) from the resulting emulsified mixture, thereby obtaining a silicone resin emulsion, and

a step of mixing the resulting silicone resin emulsion, an inorganic oxide fine particle (D) and an emulsion prepared in advance and comprising a linear organopolysiloxane (A2) having a weight average molecular weight within a range of 1,000 to 30,000, thereby preparing an aqueous clear coating composition.

In this embodiment, after preparing the silicone resin emulsion, an emulsion prepared in advance and comprising a linear organopolysiloxane (A2) having a weight average molecular weight within a range of 1,000 to 30,000 is mixed.

First, a method for producing an aqueous silicone resin emulsion for preparing a coating composition will be described, and next, a method for producing an aqueous coating composition containing a silicone resin emulsion and a method for producing an aqueous clear coating composition containing a silicone resin emulsion will be described.

### Preparation of Aqueous Silicone Resin Emulsion for Preparing Coating Composition

### Emulsification Step

The emulsification step in the preparation of the aqueous silicone resin emulsion for preparing a coating composition is a step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture. The above production method is characterized in that a mixture of the silicone resin (A) and the organic solvent (B) or a mixture of the silicone resin (A), the organic solvent (B) and the emulsifier (C) is used in the emulsification step, that a mass ratio (A):(B) of the silicone resin (A) and the organic solvent (B) in the mixture containing the silicone resin (A) and the organic solvent (B) before the mechanical emulsification treatment satisfies the relationship (A):(B)=1:2 to 1:0.2, and a mass ratio (A):(B) of the silicone resin (A) and the organic solvent (B) contained in the emulsified mixture satisfies the relationship (A):(B)=1:2 to 1:0.2.

### Silicone Resin (A)

In the above method, the silicone resin (A) comprises a branched organopolysiloxane (A1) having a weight average molecular weight within a range of 5,000 to 300,000. The weight average molecular weight of the branched organopolysiloxane (A1) is preferably in a range of 5,000 to 100,000, and more preferably in a range of 5,000 to 50,000. Thanks to the condition that the weight average molecular weight is within the above range, it is possible to prepare a silicone resin emulsion having good storage stability. Moreover, coating films obtained from the coating composition prepared using the silicone resin emulsion have an advantage of having good weatherability, water resistance, etc.

Coating compositions containing the branched organopolysiloxane (A1) have an advantage of being capable of forming coating films having good coating film strength. On the other hand, the branched organopolysiloxane (A1) has a relatively high viscosity. Therefore, when emulsifying a silicone resin containing a branched organopolysiloxane (A1) to prepare an aqueous coating composition, it may become difficult to prepare an emulsion due to high viscosity. That is because when emulsifying a highly viscous silicone resin containing the branched organopolysiloxane (A1), it may become difficult to prepare an emulsion of fine particles and the storage stability of resulting emulsions may be poor.

The above method is characterized in that in the emulsification of the silicone resin (A), emulsification is carried out in a state where the mixture before the mechanical emulsification treatment contains the silicone resin (A) and the organic solvent (B). This made it possible to prepare an emulsion of fine particles.

The branched organopolysiloxane (A1) is, for example, a compound having a structure represented by the following formula.

[R¹SiO_{3/2}]ₘ[R²₂SiO]ₙ

In the above formula, R¹ and R² are each independently a hydroxyl group or a monovalent organic group having 1 to 20 carbon atoms which may have a substituent,
m is in a range of 1 to 1,000, and
n is in a range of 0 to 100.

In the above formula, m+n is preferably in a range of 1 to 1,000.

Specific examples of R¹ and R² in the above formula include alkyl groups having 1 to 20 carbon atoms such as a methyl group, an ethyl group, a propyl group, a butyl group, a pentyl group, a hexyl group, a heptyl group, an octyl, group, a nonyl group, a decyl group, a dodecyl group, a tetradecyl group, a hexadecyl group, an octadecyl group, a cyclopentyl group, a cyclohexyl group and a cycloheptyl group; aryl groups having 6 to 20 carbon atoms such as a phenyl group, a tolyl group, a xylyl group and a naphthyl group; alkenyl groups having 2 to 20 carbon atoms such as a vinyl group and an allyl group; and a hydroxyl group. These groups may have substituents if necessary. Examples of the substituents include polar group-containing substituents such as halogen atoms, an amino group, an acryloxyl group, a methacryloxyl group, an epoxy group, a mercapto group, and a carboxyl group.

In the above formula, R¹ and R² are each independently preferably a hydroxyl group, a linear hydrocarbon group having 1 to 6 carbon atoms, or an aromatic hydrocarbon group having 5 to 7 carbon atoms.

More preferably, the branched organopolysiloxane (A1) is a compound having a structure represented by the above formula, wherein R¹ and R² each independently represent a hydroxyl group, a linear hydrocarbon group having 1 to 6 carbon atoms or an aromatic hydrocarbon group having 5 to 7 carbon atoms, m is 1 to 1,000, n is 1 to 100, and m+n is in a range of 1 to 1,000.

As to R¹ and R² in the above formula, it is more preferable that 30 mol % or more of them be methyl groups, and even more preferable that 50 mol % or more of them be methyl groups.

In the above formula, m represents the number of [R¹SiO_{3/2}] units, and n represents the number of [R²₂SiO] units. Inclusion of [R¹SiO_{3/2}] units leads to a branched organopolysiloxane. Here, the molar ratio m n of the above units is preferably in a range of 2:8 to 10:0, more preferably in a range of 3:7 to 10:0, and even more preferably 4:6 to 10:0. As to the above-mentioned ratio, the condition that the ratio of n is 8 or less is advantageous in that the hardness of a resulting coating film falls within a preferable range and good durability can be obtained.

The branched organopolysiloxane (A1) can be prepared, for example, by subjecting a silane compound such as chlorosilane or an alkoxysilane to hydrolysis and a condensation reaction. As the branched organopolysiloxane (A1), a commercially available product may be used. Examples of such a commercially available product include 804 RESIN, 805 RESIN, 840 RESIN and SR-2400 produced by Dow Corning Toray Silicone Co., Ltd.; KR-220L, KR-242A, KR-251, KR-225, KR-271, KR-282 and X40-2406 produced by Shin-Etsu Chemical Co., Ltd.; SILRES K, SILRES KX, SILRES HK 46, SILRES REN50, SILRES REN60, SILRES H 62C and SILRES MES100 produced by Wacker Asahikasei Silicone Co., Ltd.

The silicone resin (A) preferably contains a linear organopolysiloxane (A2) in addition to the branched organopolysiloxane (A1). Examples of the linear organopolysiloxane (A2) include compounds having a structure represented by the following formula.

R³-[R⁴₂SiO]ₓ-R⁵

wherein R³ is a hydroxyl group, a linear hydrocarbon group having 1 to 6 carbon atoms or an aromatic hydrocarbon group having 5 to 7 carbon atoms,

R⁴ is a linear hydrocarbon group having 1 to 6 carbon atoms or an aromatic hydrocarbon group having 5 to 7 carbon atoms,

R⁵ is hydrogen, a linear hydrocarbon group having 1 to 6 carbon atoms or an aromatic hydrocarbon group having 5 to 7 carbon atoms, x is in a range of 1 to 400.

When the silicone resin (A) contains a linear organopolysiloxane (A2) in addition to a branched organopolysiloxane (A1), a mass ratio of the branched organopolysiloxane (A1) and the linear organopolysiloxane (A2) is preferably within a range of (A1):(A2)=98:2 to 40:60. The condition that a mass ratio (A1):(A2) is within the above range is advantageous in that a resulting coating film is good in water resistance and chemical resistance.

The embodiment described above is the First Embodiment of the preparation of a silicone resin emulsion. In a method of preparing an aqueous coating composition containing a silicone resin emulsion and a method of preparing an aqueous clear coating composition containing a silicone resin emulsion, which will be described in detail below, the preparations may be carried out according to a Second Embodiment. The Second Embodiment is a method in which an emulsified mixture is prepared and a silicone resin emulsion is prepared, and then a previously prepared emulsion containing a linear organopolysiloxane (A2) is mixed. In this preparation method, the silicone resin (A) to be used for the preparation of the emulsified mixture contains a branched organopolysiloxane (A1). On the other hand, the linear organopolysiloxane (A2) may or may not be contained.

In both of the First and Second Embodiments, a mass ratio of the branched organopolysiloxane (A1) and the linear organopolysiloxane (A2) is preferably within a range of (A1):(A2)=98:2 to 40:60. The condition that a mass ratio (A1):(A2) is within the above range is advantageous in that a resulting coating film is good in water resistance and chemical resistance.

The case where the coating composition is prepared according to the First Embodiment is advantageous in that it is easy to adjust the viscosity of the mixture of the silicone resin (A) and the organic solvent (B) within an appropriate range. Furthermore, the case where the silicone resin (A) contains a linear organopolysiloxane (A2) having a relatively small molecular weight is advantageous in that it is easier to adjust the viscosity within an appropriate range.

The case where a coating composition is prepared according to the Second Embodiment is advantageous in that the physical properties of a resulting coating film can be appropriately adjusted in conformity with the performance required by intended applications because the compounding amount ratio of the silicone resin emulsion containing the branched organopolysiloxane (A1) and the silicone resin emulsion containing the linear organopolysiloxane (A2) can be appropriately determined.

### Organic Solvent (B)

The organic solvent (B) is an organic solvent which is miscible with the silicone resin (A) in any ratio and has a solubility in water of 1 g/100 g-H₂O or less, or a mixture of such organic solvents. In addition, at least one of the organic solvents in the organic solvent (B) is required to have an azeotropic point with water. The admixing of the organic solvent (B) with the silicone resin (A) means being miscible in any ratio at 20° C. In the present specification, “an organic solvent having an azeotropic point with water” means an organic solvent exhibiting a minimum azeotropic point by azeotropy when the mixture of water and an organic solvent is boiled by heating or the like. In addition, “an organic solvent having a solubility in water of 1 g/100 g-H₂O or less” means a solubility at 20° C.

In the present specification, “an organic solvent having an azeotropic point with water” means an organic solvent exhibiting a minimum azeotropic point by azeotropy when the mixture of water and an organic solvent is boiled by heating or the like. The organic solvent (B) is preferably one having an azeotropic point with water of 60° C. to 95° C. under normal pressure. The condition that the azeotropic point of the organic solvent (B) is within the above range is advantageous in that handling is easier in the emulsification step and the desolventization step.

Specific examples of the organic solvent (B) having a solubility in water of 1 g/100 g-H₂O or less and having an azeotropic point with water include organic solvents containing one or more species of hydrocarbon solvents such as benzene, toluene, xylene, hexane and cyclohexane. More preferably, the organic solvent (B) is one or more selected from the group consisting of benzene, toluene, xylene, hexane and cyclohexane, and even more preferably is selected from the group consisting of benzene, toluene, hexane and cyclohexane.

Using the above organic solvent makes it possible to easily distill off by azeotropic distillation with water in the desolventization step after obtaining an emulsified mixture. This is advantageous in that an aqueous silicone resin emulsion having reduced solvent odor and no flash point can be obtained.

Among the above-mentioned organic solvents (B), examples of organic solvents having a solubility in water of 1 g/100 g-H₂O or less and having no azeotropic point with water include aromatic organic solvents having 10 to 20 carbon atoms and having no azeotropic point with water and organic solvents being hydrocarbon organic solvents having 8 to 20 carbon atoms and having no azeotropic point with water.

### Emulsifier (C)

The emulsifier (C) to be used in the emulsification step is not particularly limited, and there can be used, for example,

anionic surfactants such as alkyl sulfates, polyoxyethylene alkyl ether sulfates, polyoxyalkylene alkenyl ether sulfates, alkyl diphenyl ether sulfates, polyoxyethylene alkyl ether acetates, alkylbenzene sulfonates, and alkenyl succinates;

cationic surfactants such as quaternary ammonium salts;

nonionic surfactants such as glycerol fatty acid esters, propylene glycol fatty acid esters, sorbitan fatty acid esters, polyoxyethylene sorbitan fatty acid esters, polyoxyethylene sorbitol fatty acid esters, polyoxyethylene alkyl ethers, polyoxyalkylene alkyl ethers, polyoxyethylene polyoxypropylene glycols, polyoxyethylene hardened castor oil, polyethylene glycol fatty acid esters, alkyl glyceryl ethers, alkyl alkanol amides, and alkyl polyglucosides;

amphoteric surfactants such as alkyl betaines, imidazoline type betaines, alkylamine oxides, alkylamidopropyl betaines, and alkylhydroxysulfobetaines.

These emulsifiers (C) may be used singly, or two or more of them may be used in combination.

The emulsifier (C) preferably contains an anionic surfactant. Using an emulsifier (C) containing an anionic surfactant is advantageous in that it is possible to obtain an emulsified mixture and an aqueous silicone resin emulsion having an average particle diameter within a suitable range and it is also possible to obtain an aqueous silicone resin emulsion being superior in storage stability.

Examples of preferable anionic surfactants include Newcol 707SN, Newcol 714SN, Newcol 780SF, Newcol 2308SF (all produced by Nippon Nyukazai Co., Ltd.), which are polyoxyethylene alkyl ether sulfates; LATEMUL PD-104 (produced by Kao Corporation) and Aqualon KH-1025 (produced by DKS Co. Ltd.), which are polyoxyalkylene alkenyl ether sulfates; NEOGEN S-20F (produced by DKS Co. Ltd.), NEOPELEX G-65 and NEOPELEX G-25 (both produced by Kao Corporation), which are alkyl benzene sulfonates; PELEX SS-L and PELEX SS-H (both produced by Kao Corporation), which are alkyl diphenyl ether sulfates; and LATEMUL ASK and LATEMUL DSK (both produced by Kao Corporation), which are alkenyl succinates.

Furthermore, examples of the emulsifier (C) include embodiments containing an anionic surfactant and a nonionic surfactant.

The amount of the emulsifier (C), expressed in the amount of components, is preferably 0.5 to 10 parts by mass, and more preferably 2.5 to 10 parts by mass, based on 100 parts by mass of the resin solid content of the silicone resin (A). The condition that the amount of the emulsifier (C) is within the above range is advantageous in that the average particle diameter can be made smaller, and when an aqueous coating composition is prepared using the obtained silicone resin emulsion, the water resistance of a coating film can be secured.

In the present specification, the aqueous medium is a medium consisting essentially of water. The aqueous medium may optionally contain a hydrophilic organic solvent such as alcohol in a range of several percent by mass.

In one embodiment of the emulsification step, first, a mixture of the silicone resin (A) and the organic solvent (B) and a mixture of the emulsifier (C) and the aqueous medium are prepared. These mixtures are then subjected to mechanical emulsification treatment to obtain an emulsified mixture. In another embodiment of the emulsification step, a mixture of the silicone resin (A), the organic solvent (B), and the emulsifier (C) is prepared, the aqueous medium is further mixed and mechanical emulsification treatment is performed, and thus an emulsified mixture is obtained. These mixtures can be prepared by performing mixing by using a stirrer commonly used in the field of coating composition. As the mixture of the silicone resin (A) and the organic solvent (B), a commercially available product may be used.

In the mixture before the mechanical emulsification treatment containing the silicone resin (A) and the organic solvent (B), the viscosity of the mixture of the silicone resin (A) and the organic solvent (B) is preferably within a range of 10 to 1,500 mPa·s, more preferably in a range of 10 to 700 mPa·s, and still more preferably in a range of 10 to 200 mPa·s. Since the viscosity of the branched organopolysiloxane (A1) having a weight average molecular weight within a range of 5,000 to 300,000 is as high as greater than 1,500 mPa·s, the viscosity of the silicone resin (A) is also high. Here, the condition that the viscosity of the mixture of the silicone resin (A) and the organic solvent (B) in the mixture before the mechanical emulsification treatment to be used in the emulsification step is within the above range is advantageous in that it is possible to prepare a silicone resin emulsion having an average particle diameter within a suitable range.

The above-described method is characterized in that the mixture before the mechanical emulsification treatment containing the silicone resin (A) and the organic solvent (B) in the emulsification step satisfies the relationship of a mass ratio (A):(B) of the silicone resin (A) and the organic solvent (B)=1:2 to 1:0.2 and a mass ratio (A):(B) of the silicone resin (A) and the organic solvent (B) contained in the emulsified mixture (that is, after emulsification) satisfies the relationship of (A):(B)=1:2 to 1:0.2. If the mass ratio of the silicone resin (A) and the organic solvent (B) is within the above-mentioned range both before and after emulsification, a silicone resin emulsion having good properties can be prepared even when the silicone resin (A) contains the branched organopolysiloxane (A1). The mass ratio (A):(B) of the silicone resin (A) and the organic solvent (B) preferably satisfies a relationship of (A):(B)=1:2 to 1:0.5, and more preferably satisfies a relationship of (A):(B)=1:2 to 1:0.67.

In the above production method, the condition that a mass ratio (A):(B) of the silicone resin (A) and the organic solvent (B) in the mixture before the mechanical emulsification treatment (that is, before emulsification) containing the silicone resin (A) and the organic solvent (B) satisfies the above range and a mass ratio (A):(B) of the silicone resin (A) and the organic solvent (B) contained in the emulsified mixture (that is, after emulsification) satisfies the above range means that a certain amount of organic solvent is present both before and after the emulsification. Therefore, the production method in the present invention does not include, for example, a production method in which the content of an organic solvent is made less than the above range by distilling off the organic solvent before emulsification.

The mass ratio (A):(B) of the silicone resin (A) and the organic solvent (B) in the mixture before the mechanical emulsification treatment (i.e., before emulsification) containing the silicone resin (A) and the organic solvent (B) is preferably (A):(B)=1:2 to 1:0.5. Further, the mass ratio (A):(B) of the silicone resin (A) and the organic solvent (B) contained in the emulsified mixture (i.e., after emulsification) is preferably (A):(B)=1:2 to 1:0.67.

In more detail, the method for obtaining the above-described emulsified mixture can be carried out, for example, by the following procedures.
Procedure 1: a procedure in which the whole of the mixture of the silicone resin (A) and the organic solvent (B) and the whole of the mixture of the emulsifier (C) and the aqueous medium are mixed and then subjected to mechanical emulsification treatment.
Procedure 2: a procedure in which a part of the mixture of the emulsifier (C) and the aqueous medium is first added to the whole of the mixture of the silicone resin (A) and the organic solvent (B), followed by mechanical emulsification treatment, and subsequently the remainder of the mixture of the emulsifier (C) and the aqueous medium is added and mechanical emulsification treatment is carried out.
Procedure 3: a procedure in which the emulsifier (C) is once mixed with the whole of the mixture of the silicone resin (A) and the organic solvent (B) and then mechanical emulsification treatment is carried out while adding the aqueous medium.
Procedure 4: a procedure in which a part of the mixture of the silicone resin (A) and the organic solvent (B) and a part of the mixture of the emulsifier (C) and the aqueous medium are first added and subjected to mechanical emulsification treatment, and subsequently the remainder of the mixtures is added and mechanical emulsification treatment is carried out.
Procedure 5: a procedure in which a part of the mixture of the silicone resin (A) and the organic solvent (B) and the whole of the mixture of the emulsifier (C) and the aqueous medium are added first, followed by mechanical emulsification treatment, and then the remainder of the mixture of the silicone resin (A) and the organic solvent (B) is added and mechanical emulsification treatment is carried out.
Procedure 6: a procedure in which a part of the mixture of the silicone resin (A) and the organic solvent (B) is added to and mixed with the whole of the mixture of the emulsifier (C) and the aqueous medium, and then the remainder of the mixture of the silicone resin (A) and the organic solvent (B) is added and mechanical emulsification treatment is carried out.

The above-mentioned mechanical emulsification treatment in the emulsification step means emulsification treatment using physical convection. Specific examples of the mechanical emulsification treatment include pressurized shear agitation treatment, counter impinging treatment, impinging agitation treatment, and high speed rotary agitation treatment.

The pressurized shear agitation treatment is treatment in which shear agitation is carried out under a pressurized condition. The pressurized condition may be, for example, a pressurized condition of 10 to 100 MPa.

The counter impinging treatment is treatment in which high pressure is applied to a liquid mixture, which is then made to counter impinge in a treatment container (for example, a homo-valve) and pass therethrough, thereby micronizing particles of an emulsion or the like. The pressurized condition may be, for example, a pressurized condition of 10 to 100 MPa. Specific examples of the counter impinging treatment include homogenizer treatment under a pressurized condition of 10 to 100 MPa. Specific examples of the counter impinging treatment also include counter impinging treatment using a high pressure homogenizer.

The impinging agitation treatment is treatment in which the object to be mixed is divided into two or more portions, which are then injected at a high pressure (for example, a pressure of 10 to 100 MPa) to collide with each other, and thus agitation is carried out. The counter impinging treatment and the impinging agitation treatment can be suitably used as a method for treating a relatively large amount of raw materials because jet-impingement can be continuously performed thereby. Specific examples of the impinging agitation treatment include impinging agitation treatment using a microfluidizer.

The high speed rotary agitation treatment is agitation treatment by rotating a needle stirrer at a high speed. The high speed rotation condition may be, for example, an embodiment in which agitation is carried out at 5,000 to 30,000 rpm. Specific examples of the high speed rotary agitation treatment include high speed rotary agitation treatment using CLEARMIX, CLEARMIX W-MOTION (manufactured by M Technique Co., Ltd.) or the like.

By subjecting a mixture before mechanical emulsification treatment containing the silicone resin (A) and the organic solvent (B) to a mechanical emulsification treatment, it is possible to prepare an emulsion having, for example, an average particle diameter falling within a range of 100 to 500 nm.

### Desolventization Step

An aqueous silicone resin emulsion for preparing a coating composition can be obtained by at least partially removing the organic solvent (B) from the emulsified mixture obtained in the emulsification step (desolventization step). As a method for removing the organic solvent (B), common desolventization methods known to those skilled in the art can be used. Examples of the desolventization method include a method of at least partially removing the organic solvent (B) by heating and/or reducing pressure by a common stirring desolventization vessel, a falling-film method, a rotary evaporator, or the like.

In the above-described production method, even a silicone resin containing a branched organopolysiloxane (A1) can be satisfactorily emulsified with a sufficiently fine particle diameter. By the above-described production method, it is possible to obtain a silicone resin emulsion suitable for the preparation of a coating composition and superior in storage stability. The average particle diameter of the silicone resin emulsion obtained by the above method is preferably in a range of 100 to 500 nm, and more preferably in a range of 100 to 400 nm.

The average particle diameter as referred to herein is an average particle diameter determined by a dynamic light scattering method, and specifically, it can be measured using an electrophoretic light scattering photometer ELSZ Series (manufactured by Otsuka Electronics Co., Ltd.) or the like.

The silicone resin emulsion produced by the above method is a silicone resin emulsion in which the silicone resin containing the branched organopolysiloxane (A1) is dispersed. Therefore, the silicone resin emulsion can be suitably used in the preparation of an aqueous coating composition.

### Preparation of Aqueous Coating Composition

Using the silicone resin emulsion produced by the above method, an aqueous coating composition can be prepared. For example, in the First Embodiment, an aqueous coating composition can be prepared by mixing the obtained silicone resin emulsion with a pigment, additives, etc., which are used as necessary, by using a stirrer commonly used by those skilled in the art.

For example, in the Second Embodiment, an aqueous coating composition can be prepared by the obtained silicone resin emulsion and an emulsion prepared in advance and containing a linear organopolysiloxane (A2) having a weight average molecular weight in a range of 1,000 to 30,000, and further mixing a pigment, additives, etc, which are used as necessary, by using a stirrer commonly used by those skilled in the art.

The emulsion containing a linear organopolysiloxane (A2) having a weight average molecular weight in a range of 1,000 to 30,000 can be prepared by a method commonly used by those skilled in the art. As the emulsion containing a linear organopolysiloxane (A2) having a weight average molecular weight in a range of 1,000 to 30,000, a commercially available product thereof may be used.

The pigment is not particularly limited, and examples thereof include extender pigments, inorganic colored pigments, and organic colored pigments. Preferably, the pigment is used with a pigment mass concentration (PWC) based on the resin solid content of the aqueous coating composition being in a range of 5 to 60% by mass.

In the preparation of the aqueous coating composition, additives commonly used, such as viscosity modifiers, fillers, dispersants, ultraviolet absorbers, light stabilizers, antioxidants, antifreeze agents, matting agents, algaecides, defoamers, film-forming aid, antiseptics, fungicides, and reaction catalysts, may be incorporated.

The aqueous coating composition preferably contains a viscosity modifier in an amount of 0.01 to 20% by mass based on the mass of the resin solid contents. The amount of the viscosity modifier is preferably 0.05 to 10% by mass, more preferably 0.5 to 5% by mass, based on the mass of the resin solid content.

Examples of the viscosity modifiers include polyamide based viscosity modifiers, urethane based viscosity modifiers, polycarboxylic acid based viscosity modifiers, cellulose based viscosity modifiers, inorganic layered compound based viscosity modifiers, and aminoplast based viscosity modifiers.

Examples of the polyamide based viscosity modifier include fatty acid amides, polyamides, acrylic amides, long-chain polyamine amides, amine amide, and salts thereof (e.g., phosphates).

Examples of the urethane based viscosity modifier include polyether polyol based urethane prepolymers and urethane-modified polyether based viscosity modifiers.

Examples of the polycarboxylic acid based viscosity modifier include high-molecular weight polycarboxylic acids, high-molecular weight unsaturated acid polycarboxylic acids, and partially amidated products thereof.

Examples of the cellulose based viscosity modifier include cellulose based viscosity modifiers such as hydroxyethyl cellulose and hydroxypropyl cellulose.

Examples of the inorganic layered compound based viscosity modifier include layered compounds such as montmorillonite, bentonite and clay.

Examples of the aminoplast based viscosity modifier include hydrophobically modified ethoxylate aminoplast based associated viscosity modifiers.

The viscosity modifiers may be used singly or in combination of two or more of them.

As the viscosity modifier, commercially available products thereof may be used. Examples of commercially available viscosity modifiers include:

DISPARLON AQ-600 (produced by Kusumoto Chemicals, Ltd.), Anti-Terra-U (produced by BYK Chemie), Disperbyk-101, Disperbyk-130 (produced by BYK Chemie), which are polyamide based viscosity modifiers;

Anti-Terra-203/204 (produced by BYK Chemie), Disperbyk-107 (produced by BYK Chemie), BYK-P104, BYK-P105 (produced by BYK Chemie), Primal ASE-60, Primal TT-615 (produced by The Dow Chemical Company), Viscalex HV-30 (produced by BASF), SN-THICKENER 617, SN-THICKENER 618, SN-THICKENER 630, SN-THICKENER 634, SN-THICKENER 636 (produced by San Nopco Ltd.), which are polycarboxylic acid based viscosity modifiers;

ADEKA NOL UH-814N, UH-752, UH-750, UH-420, UH-462 (produced by ADEKA Corporation), SN-THICKENER 621N, SN-THICKENER 623N (produced by San Nopco Ltd.), RHEOLATE 244, 278 (produced by Elementis plc), which are urethane based viscosity modifiers;

HEC Daicel SP600N (produced by Daicel FineChem Ltd.), which is a cellulose based viscosity modifier;

BENTONE HD (produced by Elements Co.), which is a layered compound based viscosity modifier; and

Optiflo H 600 VF (produced by BYK Chemie), which is an aminoplast based viscosity modifier.

It is preferable that the viscosity modifier contain one or more species of polycarboxylic acid based viscosity modifiers and urethane based viscosity modifiers. A viscosity modifier containing a polycarboxylic acid based viscosity modifier is more preferred. When the viscosity modifier contains a polycarboxylic acid based viscosity modifier, it is more preferable to use ammonia as a neutralizer. In the case where the viscosity modifier contains a polycarboxylic acid based viscosity modifier, using ammonia as a neutralizer is advantageous in that gel fraction (the mass fraction of extraction insoluble portion of a dried coating film in an organic solvent as measured in accordance with JIS K 6796) can be maintained within a favorable range.

Thanks to the inclusion of the branched organopolysiloxane (A1) having a weight average molecular weight within a range of 5,000 to 100,000, the aqueous coating composition can form a coating film superior in physical properties such as toughness and weatherability. Further, the silicone resin emulsion prepared by the above-described method, in which the silicone resin containing the branched organopolysiloxane (A1) is dispersed, is superior in storage stability. Therefore, a resulting aqueous coating composition also has an advantage of being superior in storage stability. Furthermore, the condition that the aqueous coating composition contains both the branched organopolysiloxane (A1) having a weight average molecular weight in a range of 5,000 to 100,000 and the linear organopolysiloxane (A2) having a weight average molecular weight in a range of 1,000 to 30,000 is advantageous in that a coating film superior in water resistance and chemical resistance can be formed. This is probably because, thanks to the inclusion of both components (A1) and (A2) in quantities within the specified ranges, the curing reactivity during the formation of a coating film is improved.

### Preparation of Aqueous Clear Coating Composition

Using the silicone resin emulsion produced by the above method, an aqueous clear coating composition can be prepared. For example, in the First Embodiment, an aqueous clear coating composition can be prepared by mixing the obtained silicone resin emulsion with inorganic oxide fine particles (D) as well as a pigment, additives, etc., which are used as necessary, by using a stirrer commonly used by those skilled in the art.

For example, in the Second Embodiment, an aqueous clear coating composition can be prepared by mixing the obtained silicone resin emulsion, inorganic oxide fine particles (D), and an emulsion prepared in advance and containing a linear organopolysiloxane (A2) having a weight average molecular weight in a range of 1,000 to 30,000, and further mixing a pigment, additives, etc, which are used as necessary, by using a stirrer commonly used by those skilled in the art.

In the Second Embodiment, the emulsion containing a linear organopolysiloxane (A2) having a weight average molecular weight in a range of 1,000 to 30,000 can be prepared by a method commonly used by those skilled in the art. As the emulsion containing a linear organopolysiloxane (A2) having a weight average molecular weight in a range of 1,000 to 30,000, a commercially available product thereof may be used.

### Inorganic Oxide Fine Particles (D)

The aqueous clear coating composition contains inorganic oxide fine particles (D) having an average particle diameter in a range of 20 to 300 nm. Thanks to the inclusion of the inorganic oxide fine particles (D) in the aqueous clear coating composition, the weatherability of a resulting coating film can be maintained for a long period of time while maintaining the required visible light transparency of a clear coating composition. This allows the content of the organic ultraviolet absorber commonly used in clear coating compositions to be reduced and makes it possible to prepare a clear coating composition without using any organic ultraviolet absorber.

Organic ultraviolet absorbers commonly used in clear coating compositions (for example, benzotriazole based ultraviolet absorbers and triazine based ultraviolet absorbers) have high visible light transmittance but are superior in ultraviolet blocking properties. Therefore, by using an organic ultraviolet absorber, it is possible to impart ultraviolet ray blocking properties to a coating film while maintaining the visible light transparency required in a clear coating composition. However, it has been revealed that organic ultraviolet absorbers like those described above are difficult to maintain ultraviolet ray blocking properties for a long period of time.

By using inorganic oxide fine particles (D) having an average particle diameter within the above range, it is possible to impart ultraviolet ray blocking performance while maintaining the visible light transparency required in a clear coating composition, and it has become possible to maintain ultraviolet ray blocking properties for a long period of time.

The average particle diameter of the inorganic oxide fine particles (D) is more preferably in a range of 20 to 230 nm, and still more preferably in a range of 20 to 100 nm.

In the present specification, the average particle diameter of the inorganic oxide fine particles (D) means 50% volume particle diameter (D₅₀, also referred to as volume-cumulative particle diameter D₅₀). Specifically, where the total volume of the particles integrated in the particle size distribution of the inorganic oxide fine particles (D) from the smaller particle diameter side to a certain particle size is expressed as a percentage based on the total volume of all particles, the particle diameter with a value of the percentage of 50% is adopted. The 50% volume particle diameter (D₅₀) can be measured using a laser diffraction/scattering method, for example, using UPA-150 (particle size distribution analyzer manufactured by MicrotracBEL Corp.).

Examples of the inorganic oxide constituting the inorganic oxide fine particles (D) include silicon oxide, titanium oxide, zinc oxide, tin oxide, cerium oxide, antimony oxide, and their multiple oxide. The inorganic oxide fine particles (D) preferably contain at least one member selected from the group consisting of silicon oxide, titanium oxide and zinc oxide, and from the viewpoints of ultraviolet ray absorbing performance and the visible light transparency of a coating film, more preferably contain at least one member selected from the group consisting of titanium oxide and zinc oxide. The inorganic oxide fine particles (D) also have the advantage of being capable of ensuring the storage stability of an aqueous clear coating composition.

The inorganic oxide fine particles may be surface-treated particles. They may be particles with organic surface coating of an organosilicon compound formed as surface treatment. They also may be particles inorganically surface-coated with hydroxide and/or oxide of one or more elements selected from among silicon, aluminum, zinc, iron, titanium and zirconium. Furthermore, they may be particles with both the inorganic surface coating and the organic surface coating formed.

Examples of the organic surface coating include surface coating treatment using an organosilicon compound such as a silicone compound having a hydrogen-silicon bond, e.g., methyl hydrogen polysiloxane copolymer or a compound having an alkoxy group-silicon bond as a reactive group (e.g., triethoxysilylethyl polydimethylsiloxyethyl dimethicone and triethoxysilylethyl polydimethylsiloxyethyl hexyl dimethicone). The organic surface coating treatment method is not particularly limited, and a known method such as dry treatment or wet treatment can be used. Preferably, the organic surface coating is surface treatment applied in an amount within a range of 0.1 to 20% by mass based on the mass of the inorganic oxide fine particles after the coating treatment.

The inorganic surface coating may be formed using a surface treatment agent that provides inorganic surface coating containing hydroxide and/or oxide of one or more elements selected from among silicon, aluminum, zinc, iron, titanium and zirconium. Specific examples of such a surface treatment agent include sodium silicate, tetramethyl silicate and a condensate thereof, tetraethyl silicate and a condensate thereof, sodium aluminate, sodium zirconate, aluminum sulfate, aluminum nitrate, aluminum chloride, as well as sulfates, nitrates and chlorides of the above elements.

The inorganic surface coating treatment method using the surface treatment agent is not particularly limited, and examples thereof include: a method in which inorganic oxide fine particles are dispersed in water to form a water slurry, a surface treatment agent is added to the water slurry, and then drying, calcination, and pulverization are carried out; a method in which inorganic oxide fine particles are dispersed in water to form a water slurry, a surface treatment agent is added to the water slurry, and then neutralization, washing with water, drying and pulverization are carried out; a method in which a surface treatment agent is added to inorganic oxide fine particles, and then calcination is carried out, thereby thermally decomposing the surface treatment agent. Preferably, the inorganic surface coating is surface treatment applied in an amount within a range of 0.1 to 30% by mass based on the mass of the inorganic oxide fine particles after the coating treatment.

More preferably, the surface treatment is an embodiment in which inorganic surface coating treatment is performed as a first surface treatment to form an inorganic surface coating layer, and subsequently organic surface coating treatment is performed as a second surface treatment to form an organic surface coating layer. More preferable embodiments include an embodiment in which an inorganic surface coating layer is formed using hydrous silica as the first surface treatment, and subsequently an organic surface coating layer is formed using an organopolysiloxane as the second surface treatment. Examples of inorganic oxide fine particles subjected to such surface treatment include FINEX Series produced by Sakai Chemical Industry Co., Ltd.

Examples of inorganic oxide fine particles of silicon oxide include silica fine particles having an average particle diameter within the above range. Specific examples of such silica fine particles include methanol silica sol, IPA-ST, IPA-ST-ZL, EG-ST, NPC-ST-30, DMAC-ST, MEK-ST, MIBK-ST, XBA-ST, PMA-ST and PGM-ST, which are organosilica sols produced by Nissan Chemical Corporation.

Examples of inorganic oxide fine particles of titanium oxide include 1120Z, 2120Z, 6320Z produced by JGC Catalysts and Chemicals Ltd., TECNADIS-TI 220 produced by TECNAN, STR Series produced by Sakai Chemical Industry Co., Ltd., and TTO Series produced by Ishihara Sangyo Kaisha, Ltd.

Examples of inorganic oxide fine particles of tin oxide include CX-S303IP, CX-S301H, CX-S501M and CX-S505M produced by Nissan Chemical Corporation.

Examples of inorganic oxide fine particles of cerium oxide include CE-20A produced by Nissan Chemical Corporation and TECNADIS-CE-220 produced by TECNAN.

Examples of inorganic oxide fine particles of zinc oxide include F-2, F-1 produced by Hakusuitech Co., Ltd., ZnO-310, ZnO-410, ZnO-510 produced by Sumitomo Osaka Cement Co., Ltd., TECNADIS-ZN-220 produced by TECNAN, FINEX Series produced by Sakai Chemical Industry Co., Ltd., and FZO Series produced by Ishihara Sangyo Kaisha, Ltd.

Examples of inorganic oxide fine particles of antimony oxide include PATOX-U produced by Nihon Seiko Co., Ltd.

Examples of inorganic oxide fine particles of a multiple oxide of metal oxides include a multiple oxide (ZnSb₂O₆) of zinc oxide (ZnO) and antimony pentoxide (Sb₂O₅). Specific examples of such multiple oxide include CX-Z210IP-F2, CX-Z330H and CX-Z610M-F2 produced by Nissan Chemical Corporation.

Preferably, the inorganic oxide fine particles (D) are subjected to wet dispersion treatment. Performing wet dispersion treatment is advantageous in that the average particle diameter of the inorganic oxide fine particles (D) can be suitably controlled within a range of 20 to 300 nm. As the wet dispersion treatment, a dispersion treatment method commonly used in the art (for example, Disper dispersion and mill dispersion) can be used. The viscosity at the time of dispersion is preferably 300 mPa·s or less, more preferably 100 mPa·s or less.

Preferably, the inorganic oxide fine particles (D) are inorganic oxide fine particles obtained by an agitation treatment process involving agitation using medium particles having an average particle diameter of 0.01 to 0.1 mm. Performing the agitation treatment of the inorganic oxide fine particles (D) using the medium particles is advantageous in that the average particle diameter of the inorganic oxide fine particles (D) can be adjusted within a more preferable range. As agitation using medium particles, wet medium agitation is preferably used.

While the material of the medium particles is not particularly limited, examples thereof include alumina, zirconia, silicon carbide, silicon nitride, glass, steel, stainless steel, and pottery. From the viewpoint of adjustment efficiency of the particle diameter of the inorganic oxide fine particles (D), the material of the medium particles is preferably zirconia.

Wet medium agitation is an agitation method in which inorganic oxide fine particles are finely divided in a liquid containing a dispersant and an aqueous medium in the presence of medium particles. The particle diameter of the medium particles to be used in the wet medium agitation is preferably 0.015 mm or more and 0.1 mm or less, and more preferably 0.015 mm or more and 0.05 mm or less.

As the dispersant, a polymer dispersant, which is a dispersant used in the field of coating composition, can be preferably used. Examples of the polymer dispersant include dispersants having a polyester-based, polyacrylic-based, polyurethane-based, polyamine-based, or polycaprolactone-based main chain and having polar groups such as amino group, carboxy group, sulfo group and hydroxy group on side chains.

Specific examples of the polymer dispersant include: (co)polymers of unsaturated carboxylic acid esters, such as polyacrylic acid esters;

copolymers of an aromatic vinyl compound, such as styrene and α-methylstyrene, and an unsaturated carboxylic acid ester, such as an acrylic acid ester;

(partial) amine salts, (partial) ammonium salts or (partial) alkylamine salts of unsaturated carboxylic acid (co)polymers, such as polyacrylic acid;

hydroxyl group-containing unsaturated carboxylic acid ester (co)polymers, such as hydroxyl group-containing polyacrylic acid ester, or modified products thereof;

polyurethanes; unsaturated polyamides; polysiloxanes; long chain polyamine amide phosphate salts; polyethyleneimine derivatives (amides obtained by reaction of poly(lower alkylene imine) with free carboxyl group-containing polyester, or bases thereof); polyallylamine derivatives (reaction products obtained by reacting polyallylamine with one or more compounds selected from among three compounds, namely, a polyester having free carboxyl group, a polyamide, and a poly-co-condensate of ester and amide (i.e., a polyester amide)).

As the polymer dispersant, a commercially available product may be used. Examples of such commercially available products include DISPERBYK Series (produced by BYK Chemie), Solsperse Series (produced by The Lubrizol Corporation), EFKAPOLYMER Series (produced by BASF), and SN-DISPERSANT Series (produced by San Nopco Ltd.).

The aqueous medium contains water. In addition to water, the aqueous medium may further contain an organic solvent as required. Examples of organic solvents that can be included in the aqueous medium include alcohol solvents such as methanol, ethanol, propanol, and butanol; ketone solvents such as methyl ethyl ketone, acetone, methyl isobutyl ketone, and cyclohexanone; ether solvents such as diethyl ether, isopropyl ether, tetrahydrofuran, dioxane, ethylene glycol dimethyl ether, ethylene glycol diethyl ether, diethylene glycol dimethyl ether, diethylene glycol diethyl ether, propylene glycol monomethyl ether, anisole, and phenetole; ester solvents such as ethyl acetate, butyl acetate, isopropyl acetate, and ethylene glycol diacetate; amide solvents such as dimethylformamide, diethylformamide, and N-methylpyrrolidone; and Cellosolve solvents such as Methyl Cellosolve, Ethyl Cellosolve, and Butyl Cellosolve. Inclusion of the organic solvent in the aqueous medium is advantageous in that the inorganic oxide fine particles can be better wet-dispersed.

The amount of the inorganic oxide fine particles (D) contained in the aqueous clear coating composition is preferably 7 to 30 parts by mass, more preferably 10 to 30 parts by mass, based on 100 parts by mass of the total resin solid content of the branched organopolysiloxane (A1) and the linear organopolysiloxane (A2) to be used as required. The condition that the amount of the inorganic oxide fine particles (D) is within the above range is advantageous in that the weatherability of a resulting coating film can be improved while maintaining the required visible light transparency of a clear coating composition.

The aqueous clear coating composition may contain a pigment other than the inorganic oxide fine particles (D) as necessary. However, in the case of using such other pigment, it is required to be of a type and quantity that are not significantly detrimental to the transparency of the aqueous clear coating composition. Such other pigments are not particularly limited as long as the above conditions are satisfied, and examples thereof include extender pigments, inorganic coloring pigments, and organic pigments.

In the preparation of the above-described aqueous clear coating composition, additives commonly used, such as viscosity modifiers, fillers, dispersants, ultraviolet absorbers, light stabilizers, antioxidants, matting agents, antifreeze agents, algaecides, defoamers, film-forming aid, antiseptics, fungicides, and reaction catalysts, may be incorporated.

The aqueous clear coating composition preferably contains a viscosity modifier in an amount of 0.01 to 20% by mass based on the mass of the resin solid contents. As the viscosity modifier, the above-described viscosity modifiers can be suitably used. The amount of the viscosity modifier is preferably 0.05 to 10% by mass, more preferably 0.5 to 5% by mass, based on the mass of the resin solid content.

By containing a branched organopolysiloxane (A1) having a weight average molecular weight within a range of 5,000 to 100,000, the aqueous clear coating composition can form a coating film superior in physical properties such as toughness and weatherability. Further, the silicone resin emulsion prepared by the above-described method, in which the silicone resin containing the branched organopolysiloxane (A1) is dispersed, is superior in storage stability. Therefore, a resulting aqueous clear coating composition also has an advantage of being superior in storage stability. Furthermore, thanks to the inclusion of the inorganic oxide fine particles (D), the aqueous clear coating composition has an advantage of being capable of forming a clear coating film with further improved weatherability. In addition, the aqueous clear coating composition has characteristics of having visible light transmissibility, being superior in clear performance, but also having good ultraviolet ray blocking properties. Therefore, it also has an advantage of being capable of preventing ultraviolet degradation of a coating film and a substrate existing under a clear coating film.

Furthermore, the case where the aqueous clear coating composition contains both the branched organopolysiloxane (A1) having a weight average molecular weight in a range of 5,000 to 100,000 and the linear organopolysiloxane (A2) having a weight average molecular weight in a range of 1,000 to 30,000 is advantageous in that a coating film with good water resistance and superior chemical resistance can be formed. This is probably because, thanks to the inclusion of both components (A1) and (A2) in quantities within the specified ranges, the curing reactivity during the formation of a coating film is improved.

### EXAMPLES

The present invention will be described hereafter in more detail by way of examples, to which the present invention is not intended to be limited. In the following examples, all designations of “part(s)” and “%” are on a mass basis, unless otherwise stated.

### 1. Examples and Comparative Examples of Aqueous Silicone Resin Emulsions for Preparing a Coating Composition

### Example 1-1

### Production of Silicone Resin Emulsion

To a stainless steel container were added 25 parts by mass of LATEMUL PD-104 (produced by Kao Corporation, anionic emulsifier; content of components: 20% by mass) as emulsifier (C-1) and 152 parts by mass of ion-exchanged water, and then 200 parts by mass of SR-2400 (produced by Dow Corning Toray Silicone Co., Ltd., branched organopolysiloxane (A1); weight average molecular weight: 20,000, viscosity: 15 mPa·s, solid concentration: 50% by mass, organic solvent (B-1): toluene) was added as silicone resin (A1-1) with stirring and was stirred for 15 minutes at 1,500 rpm using a disper (total quantity: 377 parts by mass, solid content: 105 parts by mass).

Subsequently, 0.057 parts by mass of SN-777 (produced by San Nopco Ltd., defoamer) was added and was treated at 35 MPa using a high pressure homogenizer H20-H2 (manufactured by Sanwa Engineering Co., Ltd.) (mechanical emulsification treatment; emulsification step), and thus 377 parts by mass of an emulsified mixture was obtained.

Furthermore, the emulsified mixture was heated to 55° C. and desolventized under reduced pressure, so that the organic solvent (B-1) was distilled off together with water (desolventization step), and thus 247 parts by mass of silicone resin emulsion 1 for preparing a coating composition (solid concentration: 42% by mass) was obtained. The obtained silicone resin emulsion 1 for preparing a coating composition had an average particle diameter of 345 nm.

Further, the content of the organic solvent (toluene (B-1)) in the obtained silicone resin emulsion 1 was measured to be less than 0.1% by mass.

### Example 1-2

In the same manner as in Example 1 except that the mechanical emulsification treatment was carried out at 100 MPa using a Microfluidizer M-110 EH (manufactured by Powrex Corporation), 246 parts by mass of silicone resin emulsion 2 for preparing a coating material (solid concentration: 43% by mass) was obtained. The obtained silicone resin emulsion 2 for preparing a coating composition had an average particle diameter of 252 nm.

### Example 1-3

To a stainless steel container were added 25 parts by mass of the emulsifier (C-1) and 202 parts by mass of ion-exchanged water, and then 250 parts by mass of X40-2406M (produced by Shin-Etsu Chemical Co., Ltd., branched organopolysiloxane (A1); weight average molecular weight: 40,000, viscosity: 20 mPa·s, solid concentration: 40% by mass, organic solvent (B-2): xylene) was added as silicone resin (A1-2) with stirring and was stirred for 15 minutes at 1,500 rpm using a disper (total quantity: 477 parts by mass, solid content: 105 parts by mass).

Subsequently, 0.057 parts by mass of SN-777 was added and then was treated at 35 MPa using a high pressure homogenizer H20-H2 (manufactured by Sanwa Engineering Co., Ltd.), and thus 477 parts by mass of an emulsified mixture was obtained.

Furthermore, the emulsion was heated to 55° C. and desolventized under reduced pressure, so that the organic solvent (B-2) was distilled off together with water, and thus 247 parts by mass of silicone resin emulsion 3 for preparing a coating composition (solid concentration: 42% by mass) was obtained.

The obtained silicone resin emulsion 3 for preparing a coating composition had an average particle diameter of 320 nm.

### Example 1-4

To a stainless steel container were added 25 parts by mass of emulsifier (C-1) and 185 parts by mass of ion-exchanged water, and then 167 parts by mass of 804RESIN (produced by Dow Corning Toray Silicone Co., Ltd., branched organopolysiloxane (A1); weight average molecular weight: 5,000, viscosity: 30 mPa·s, solid concentration: 60% by mass, organic solvent (B-1): toluene) was added as silicone resin (A1-3) with stirring and was stirred for 15 minutes at 1,500 rpm using a disper (total quantity: 377 parts by mass, solid content: 105 parts by mass).

Subsequently, 0.057 parts by mass of SN-777 was added and then was treated at 35 MPa using a high pressure homogenizer H20-H2 (manufactured by Sanwa Engineering Co., Ltd.), and thus 377 parts by mass of an emulsified mixture was obtained.

Furthermore, the emulsion was heated to 55° C. and desolventized under reduced pressure, so that the organic solvent (B-1) was distilled off together with water, and thus 245 parts by mass of silicone resin emulsion 4 for preparing a coating composition (solid concentration: 43% by mass) was obtained.

The obtained silicone resin emulsion 4 for preparing a coating composition had an average particle diameter of 310 nm.

### Example 1-5

In a stainless steel container were mixed 140 parts by mass of silicone resin (A1-1) and 30 parts by mass of YF-3800 (produced by Momentive Performance Materials Inc., linear organopolysiloxane; weight average molecular weight: 4,000, viscosity: 70 mPa·s, solid concentration: 100% by mass) as silicone resin (A2-2), and thus 170 parts by mass of a mixture was obtained. The obtained mixture had a viscosity of 51 mPa·s.

To another stainless steel container were added 25 parts by mass of emulsifier (C-1) and 182 parts by mass of ion-exchanged water, 170 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2 (manufactured by Sanwa Engineering Co., Ltd.), and thus 377 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion 5 for preparing a coating composition (solid concentration: 43% by mass) was obtained.

The obtained silicone resin emulsion 5 for preparing a coating composition had an average particle diameter of 350 nm.

### Example 1.6

In a stainless steel container were mixed 140 parts by mass of silicone resin (A1-1) and 30 parts by mass of silicone resin (A2-2), and thus 170 parts by mass of a mixture was obtained. The obtained mixture had a viscosity of 51 mPa·s.

To another stainless steel container were added 10 parts by mass of emulsifier (C-1), 3 parts by mass of LATEMUL PD-430 (produced by Kao Corporation, nonionic; content of components: 100% by mass) as emulsifier (C-3), and 194 parts by mass of ion-exchanged water, 170 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2 (manufactured by Sanwa Engineering Co., Ltd.), and thus 377 parts by mass of an emulsified mixture was obtained.

Furthermore, the emulsion was heated to 55° C. and desolventized under reduced pressure, so that organic solvent (B-1) was distilled off together with water, and thus 247 parts by mass of silicone resin emulsion 6 for preparing a coating composition (solid concentration: 42% by mass) was obtained.

The obtained silicone resin emulsion 6 for preparing a coating composition had an average particle diameter of 365 nm.

### Example 1-7

In a stainless steel container equipped with a high shear disper, 190 parts by mass of silicone resin (A1-1) and 5 parts by mass of KR-220LP (manufactured by Shin-Etsu Chemical Co., Ltd., branched organopolysiloxane (A1); weight average molecular weight: 900, powdery form, solid concentration: 100% by mass) as silicone resin (A1-4) were mixed, and thus 195 parts by mass of a mixture was obtained. The obtained mixture had a viscosity of 25 mPa·s.

To the mixture was added 10 parts by mass of PELEX SS-H (produced by Kao Corporation, anionic; content of components: 50 mass %) as emulsifier (C-2), and 172 parts by mass of ion-exchanged water was added over 30 minutes with stirring at 8,000 rpm, and thus an emulsified mixture was obtained (total amount 377 parts by mass, solid content: 105 parts by mass).

Subsequently, following adding 0.057 parts by mass of SN-777, the mixture was heated to 55° C. and desolventized under reduced pressure, so that organic solvent (B-1) was distilled off together with water, and thus 244 parts by mass of silicone resin emulsion 7 for preparing a coating composition (solid concentration: 43% by mass) was obtained.

The obtained silicone resin emulsion 7 for preparing a coating composition had an average particle diameter of 390 nm.

### Example 1-8

In a stainless steel container were mixed 140 parts by mass of silicone resin (A1-1), 30 parts by mass of silicone resin (A2-2) and 40 parts by mass of Cactus Solvent P-150 (produced by JXTG Nippon Oil & Energy Corporation) as organic solvent (B-3), and thus 210 parts by mass of a mixture was obtained. The obtained mixture had a viscosity of 30 mPa·s.

To another stainless steel container were added 25 parts by mass of emulsifier (C-1) and 142 parts by mass of ion-exchanged water, 210 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 (produced by San Nopco Ltd., defoamer) was added and then was treated at 35 MPa using a high pressure homogenizer H20-H2 (manufactured by Sanwa Engineering Co., Ltd.), and thus 377 parts by mass of an emulsified mixture was obtained.

Furthermore, the emulsion was heated to 55° C. and desolventized under reduced pressure, so that organic solvent (B-1) was distilled off together with water, and thus 247 parts by mass of silicone resin emulsion 8 for preparing a coating composition (solid concentration: 42% by mass) was obtained.

The obtained silicone resin emulsion 8 for preparing a coating composition had an average particle diameter of 385 nm.

### Example 1-9

To a stainless steel container were added 10 parts by mass of emulsifier (C-3) and 172 parts by mass of ion-exchanged water, 200 parts by mass of silicone resin (A1-1) was added with stirring, and the mixture was stirred at 1,500 rpm for 15 minutes using a disper (total quantity: 382 parts by mass, solid content: 110 parts by mass).

Subsequently, 0.057 parts by mass of SN-777 was added and then was treated at 35 MPa using a high pressure homogenizer H20-H2 (manufactured by Sanwa Engineering Co., Ltd.), and thus 382 parts by mass of an emulsified mixture was obtained.

Furthermore, the emulsified mixture was heated to 55° C. and desolventized under reduced pressure, so that organic solvent (B-1) was distilled off together with water, and thus 252 parts by mass of silicone resin emulsion 9 for preparing a coating composition (solid concentration: 44% by mass) was obtained.

The obtained silicone resin emulsion 9 for preparing a coating composition had an average particle diameter of 495 nm.

### Comparative Example 1-1

In a stainless steel container equipped with a desolventization device were mixed 140 parts by mass of silicone resin (A1-1), 30 parts by mass of silicone resin (A2-2) and 15 parts by mass of organic solvent (B-3), and thus 185 parts by mass of a mixture was obtained. The obtained mixture was heated to 75° C. and desolventized under reduced pressure, so that 70 parts by mass of organic solvent (B-1) was distilled off. The mixture had a viscosity of 1,900 mPa·s.

To another stainless steel container were added 25 parts by mass of emulsifier (C-1) and 93 parts by mass of ion-exchanged water, 115 parts by mass of the above mixture was added with stirring, and the mixture was stirred at 1,500 rpm for 15 minutes using a disper (total quantity: 233 parts by mass, solid content: 105 parts by mass).

Subsequently, 0.057 parts by mass of SN-777 was added and then was treated at 35 MPa using a high pressure homogenizer H20-H2 (manufactured by Sanwa Engineering Co., Ltd.), and thus 233 parts by mass (solid concentration: 43% by mass) of silicone resin emulsion 11 was obtained.

The obtained silicone resin emulsion 11 had an average particle diameter of 1,780 nm. When the silicone resin emulsion 11 was allowed to stand for 1 day, separation and sedimentation occurred.

### Comparative Example 1-2

To a stainless steel container equipped with a disper were added 25 parts by mass of emulsifier (C-1) and 93 parts by mass of ion-exchanged water, 200 parts by mass of silicone resin (A1-1) was mixed with stirring at 1,500 rpm, and the mixture was stirred for 15 minutes (total quantity: 318 parts by mass, solid content: 105 parts by mass).

The obtained silicone resin emulsion 12 had an average particle diameter of 10,000 nm or more. In addition, when the silicone resin emulsion 12 was allowed to stand for 1 day, separation and sedimentation occurred.

### Comparative Example 1-3

In a stainless steel container equipped with a desolventization device were mixed 200 parts by mass of silicone resin (A1-1) and 100 parts by mass of butoxypropanol as organic solvent (b-1), and thus 300 parts by mass of a mixture was obtained. The obtained mixture was heated to 75° C. and desolventized under reduced pressure, so that 100 parts by mass of organic solvent (B-1) was distilled off, and thus 200 parts by mass of a resin mixture containing only (b-1) as an organic solvent was obtained. The mixture had a viscosity of 17 mPa·s.

To another stainless steel container were added 25 parts by mass of emulsifier (C-1) and 152 parts by mass of ion-exchanged water, 200 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2 (manufactured by Sanwa Engineering Co., Ltd.), and thus 377 parts by mass (solid content: 105 parts by mass) of a silicone resin emulsion was obtained.

Furthermore, the emulsion was heated to 55° C. and desolventized under reduced pressure, so that 130 parts by mass in total of water and organic solvent (b-2) were distilled off, and thus 247 parts by mass of silicone resin emulsion 13 (solid concentration: 42% by mass) was obtained. While the obtained silicone resin emulsion 13 had an average particle diameter of 315 nm, separation and sedimentation occurred when it was allowed to stand for 30 days.

### Comparative Example 1-4

To a stainless steel container were added 25 parts by mass of emulsifier (C-1) and 93 parts by mass of ion-exchanged water, 200 parts by mass of silicone resin (A1-1) was added with stirring, and the mixture was stirred at 1,500 rpm for 15 minutes using a disper (total quantity: 318 parts by mass, solid content: 105 parts by mass).

Subsequently, 0.057 parts by mass of SN-777 (produced by San Nopco Ltd., defoamer) was added and then was treated at 35 MPa using a high pressure homogenizer H20-H2 (manufactured by Sanwa Engineering Co., Ltd.), and thus 318 parts by mass of silicone resin emulsion 14 was obtained.

The obtained silicone resin emulsion 14 had an average particle diameter of 360 nm.

### Comparative Example 1-5

To a stainless steel container were added 25 parts by mass of emulsifier (C-1) and 302 parts by mass of ion-exchanged water, a mixture of 200 parts by mass of silicone resin (A1-1) and 150 parts by mass of (B-3) prepared in advance was added with stirring, and the resultant was stirred at 1,500 rpm for 15 minutes using a disper (total quantity: 677 parts by mass, solid content: 105 parts by mass).

Subsequently, 0.057 parts by mass of SN-777 (produced by San Nopco Ltd., defoamer) was added and then was treated at 35 MPa using a high pressure homogenizer H20-H2 (manufactured by Sanwa Engineering Co., Ltd.), and thus 677 parts by mass of an emulsified mixture was obtained.

Furthermore, the emulsified mixture was heated to 55° C. and desolventized under reduced pressure, so that organic solvents (B-1) and (B-3) was distilled off together with water, and thus 397 parts by mass of silicone resin emulsion 15 for preparing a coating composition (solid concentration: 26% by mass) was obtained. The obtained silicone resin emulsion 15 for preparing a coating composition had an average particle diameter of 310 nm.

The silicone resins (A) used in each Example and Comparative Example are as shown in the following Table 1.

TABLE 1

| | | | | Weight average | | | |
|---|---|---|---|---|---|---|---|
| Silicone | | | Structure of | molecular | | Solvent | Solid |
| resin | Product name | Manufacturer's name | organopolysiloxan | weight | m/n | (B) | concentration |
| (A1-1) | SR-2400 | Dow Corning Toray | Branched | 20000 | 180/60 | Toluene | 50 |
| | | Silicone Co., Ltd. | | | | (B-1) | |
| (A1-2) | X40-2406M | Shin-Etsu Chemical | Branched | 40000 | 510/80 | Xylene | 40 |
| | | Co. Ltd. | | | | (B-2) | |
| (A1-3) | 804 RESIN | Dow Corning Toray | Branched | 5000 | 60/20 | Toluene | 60 |
| | | Silicone Co., Ltd. | | | | (B-1) | |
| (A2-2) | YF-3800 | Momentive Performance | Liner | 4000 | 0/60 | — | 100 |
| | | Materials Inc. | | | | | |
| (A1-4) | KR-220LP | Shin-Etsu Chemical | Branched | 900 | 15/0 | — | 100 |
| | | Co., Ltd. | | | | | |

The m/n value of the silicone resins was calculated from the weight average molecular weight measured by a gel permeation chromatograph HLC-8220GPC (manufactured by Tosoh Corporation) and the compositional ratio of R¹SiO_{3/2} and R²₂SiO determined from 29Si-NMR DPX400 (manufactured by Bruker).

In addition, the organic solvents (B) and the emulsifiers (C) used in each Example and Comparative Example are as follows.
Organic solvent (B-1): toluene (azeotropic point with water: 85° C., solubility in water: 0.047 g/100 g-H₂O)
Organic solvent (B-2): xylene (azeotropic point with water: 94.5° C., solubility in water: 0 g/100 g-H₂O)
Organic solvent (B-3): Cactus Solvent P-150 (manufactured by JXTG Nippon Oil & Energy Corporation, azeotropic point with water: no, solubility in water: 0.04 g/100 g-H₂O)
Organic solvent (b-1): butoxypropanol (azeotropic point with water: no, solubility in water: 5.5 g/100 g-H₂O)
Emulsifier (C-1): LATEMUL PD-104 (produced by Kao Corporation, anionic, content of components: 20% by mass)
Emulsifier (C-2): PELEX SS-H (produced by Kao Corporation, anionic, content of components: 50% by mass)
Emulsifier (C-3): LATEMUL PD-430 (produced by Kao Corporation, nonionic, manufactured by Kao Corporation, content of components: 100% by mass)

Using the emulsified mixtures and the silicone resin emulsions prepared in the above Examples and Comparative Examples, the following evaluations were carried out. The obtained evaluation results are shown in Table 2 below.

### Viscosity Measurement

The viscosity of the mixture before mechanical emulsification treatment containing the silicone resin (A) and the organic solvent (B) was measured with a TVB-10 type viscometer (TVB-10H, manufactured by Toki Sangyo Co., Ltd.; measurement temperature: 25° C., rotation speed: 60 rpm).

### Particle Diameter Measurement

The average particle diameter of the emulsified mixtures and the silicone resin emulsions was measured using an electrophoretic light scattering photometer ELSZ (manufactured by Otsuka Electronics Co., Ltd.) by diluting their aqueous dispersions with deionized water so that the signal level became appropriate.

### State of Silicone Resin Emulsion

The state of the silicone resin emulsion was evaluated as follows. The resultant silicone resin emulsion was filtered through a 200 mesh filter and then allowed to stand at room temperature for 1 day, and the resulting state was visually observed and evaluated according to the following criteria.
◯: Separation/sedimentation did not occur.
×: Separation/sedimentation occurred.

### Odor Evaluation

The odor of the silicone resin emulsions was evaluated according to the following criteria.
◯: No odor is felt.
Δ: Odor is felt slightly.
×: Odor is felt obviously.

### Measurement of Residual Amount of Solvent

The residual amount of toluene (B-1) or xylene (B-2) contained in the silicone resin emulsions was measured using a gas chromatograph GC-2014 (manufactured by Shimadzu Corporation).

### Measurement of Flash Point

The flash point of the silicone resin emulsion was measured according to JIS K 2265-2 using Seta Closed Cup Flash Point Tester, Setaflash 33000-0 (manufactured by Stanhope-Seta Ltd.).

### Storage Stability Evaluation

Each of the silicone resin emulsions obtained in the above Examples and Comparative Examples was filtered through a 200 mesh filter and then was allowed to stand at 40° C. for 3 months. The state of the silicone resin emulsion after standing was visually observed and was evaluated according to the following criteria.
◯: No separation/sedimentation, etc. occurred.
×: Separation/sedimentation occurred.

TABLE 2

| | | | | | Ex. 1-1 | Ex. 1-2 | Ex. 1-3 | Ex. 1-4 | Ex. 1-5 | Ex. 1-6 |
|---|---|---|---|---|---|---|---|---|---|---|
| | | | | Weight average | | | | | | |
| | | Type | Structure | molecular weight | | | | | | |
| Emulsified | Silicone | (A1-1) | Branched | 20,000 | 100 | 100 | | | 70 | 70 |
| mixture | resin (A) | (A1-2) | Branched | 40,000 | | | 100 | | | |
| | | (A1-3) | Branched | 5,000 | | | | 100 | | |
| | | (A2-2) | Liner | 4,000 | | | | | 30 | 30 |
| | | (A1-4) | Branched | 900 | | | | | | |
| | | | | Solubility in water | | | | | | |
| | | Type | Name | (g/100 gH₂O) | | | | | | |
| | Organic | (B-1) | Toluene | 0.047 | 100 | 100 | | 67 | 70 | 70 |
| | solvent (B) | (B-2) | Xylene | 0 | | | 150 | | | |
| | | (B-3) | Cactus | 0.04 | | | | | | |
| | | | Solvent P-150 | | | | | | | |
| | | (b-1) | Butoxy- | 5.5 | | | | | | |
| | | | propanol | | | | | | | |
| | | Type | Structure | | | | | | | |
| | Emulsifier | (C-1) | Anion | | 5 | 5 | 5 | 5 | 5 | 2 |
| | (C) | (C-2) | Anion | | | | | | | |
| | | (C-3) | Nonion | | | | | | | 3 |
| | Aqueous | Ion | | | 172 | 172 | 222 | 205 | 202 | 202 |
| | medium | exchanged | | | | | | | | |

| | | | | | | | | | |
|---|---|---|---|---|---|---|---|---|---|
| Step | Desolventization | Distill of | Amounts of distilled | | | | | | |
| | step | solvent | organic solvent | | | | | | |
| | | before | (Desolvation amount (g)) | | | | | | |
| | | emulsificatio [symbol] | | | | | | | |
| | Before | | Mass ratio (A):(B) before mechanical | 1:1 | 1:1 | 1:1.5 | 1:0.67 | 1:0.7 | 1:0.7 |
| | emulsification | | emulsification treatment (A):(B) | | | | | | |
| | step | | Viscosity of mixture (A) + (B) before | 15 | 15 | 20 | 30 | 51 | 51 |
| | | | mechanical emulsification treatment | | | | | | |
| | | | (mPa · s) | | | | | | |
| | After | Mechanical | Shear force | 35 MPa | 100 MPa | 35 MPa | 35 MPa | 35 MPa | 35 MPa |
| | emuisification | emulsification | High speed rotary agitation | | | | | | |
| | step | treatment | treatment (disper stirring) | | | | | | |
| | | | Counter impinging treatment (high | ● | | ● | ● | ● | ● |
| | | | presurred homogeniser) | | | | | | |
| | | | Impinging agitation treatment | | ● | | | | |
| | | | (microfluidizer) | | | | | | |
| | | | Mass ratio (A):(B) in emulsified | 1:1 | 1:1 | 1:1.5 | 1:0.67 | 1:0.7 | 1:0.7 |
| | | | mixture | | | | | | |
| | | | Particle diameter of emulsified | 355 | 250 | 350 | 315 | 360 | 360 |
| | | | mixture (nm) | | | | | | |
| | Desolventization | Distill of | Amounts of distilled organic | 130 | 131 | 230 | 132 | 133 | 130 |
| | step | solvent after | solvent | | | | | | |
| | | emulsificatio [symbol] | (Desolvation amount (g)) | | | | | | |

| | | | | | | | |
|---|---|---|---|---|---|---|---|
| Evaluation | Average particle diameler of silicone resin emulsion for preparing a | 345 | 252 | 320 | 310 | 350 | 365 |
| | coating composition (nm) | | | | | | |
| | State of silicone resin emulsion for preparing a coating composition | ◯ | ◯ | ◯ | ◯ | ◯ | ◯ |
| | Odor | ◯ | ◯ | ◯ | ◯ | ◯ | ◯ |
| | Flash point (° C.) | >80 | >80 | >80 | >80 | >80 | >80 |
| | Residual amount of organic solvent (%) | <0.1 | <0.1 | 0.8 | <0.1 | <0.1 | <0.1 |
| | Strage stability | ◯ | ◯ | ◯ | ◯ | ◯ | ◯ |

| | | | | | Ex. 1-7 | Ex. 1-8 | Ex. 1-9 | Com. Ex. 1-1 | Com. Ex. 1-2 |
|---|---|---|---|---|---|---|---|---|---|
| | | | | Weight average | | | | | |
| | | Type | Structure | molecular weight | | | | | |
| Emulsified | Silicone | (A1-1) | Branched | 20,000 | 95 | 70 | 100 | 70 | 100 |
| mixture | resin (A) | (A1-2) | Branched | 40,000 | | | | | |
| | | (A1-3) | Branched | 5,000 | | | | | |
| | | (A2-2) | Liner | 4,000 | | 30 | | 30 | |
| | | (A1-4) | Branched | 900 | 5 | | | | |
| | | | | Solubility in water | | | | | |
| | | Type | Name | (g/100 gH₂O) | | | | | |
| | Organic | (B-1) | Toluene | 0.047 | 95 | 70 | 100 | 70 | 100 |
| | solvent (B) | (B-2) | Xylene | 0 | | | | | |
| | | (B-3) | Cactus | 0.04 | | 40 | | 15 | |
| | | | Solvent P-150 | | | | | | |
| | | (b-1) | Butoxy- | 5.5 | | | | | |
| | | | propanol | | | | | | |
| | | Type | Structure | | | | | | |
| | Emulsifier | (C-1) | Anion | | | 5 | | 5 | 5 |
| | (C) | (C-2) | Anion | | 5 | | | | |
| | | (C-3) | Nonion | | | | 10 | | |
| | Aqueous | Ion | | | 177 | 162 | 172 | 113 | 113 |
| | medium | exchanged | | | | | | | |

| | | | | | | | | |
|---|---|---|---|---|---|---|---|---|
| Step | Desolventization | Distill of | Amounts of distilled organic | | | | 70 | |
| | step | solvent | solvent | | | | | |
| | | before | (Desolvation amount (g)) | | | | | |
| | | emulsificatio [symbol] | | | | | | |
| | Before | | Mass ratio (A):(B) before mechanical | 1:0.95 | 1:1.1 | 1:1 | 1:0.15 | 1:1 |
| | emulsification | | emulsification treatment (A):(B) | | | | | |
| | step | | Viscosity of mixture (A) + (B) before | 25 | 30 | 15 | 1,900 | 15 |
| | | | mechanical emulsification treatment | | | | | |
| | | | (mPa · s) | | | | | |
| | After | Mechanical | Shear force | 8,000 rpm | 35 MPa | 35 MPa | 35 MPa | 1,500 rpm |
| | emuisification | emulsification | High speed rotary agitation | ● | | | | — |
| | step | treatment | treatment (disper stirring) | | | | | |
| | | | Counter impinging treatment (high | | ● | ● | ● | — |
| | | | presurred homogeniser) | | | | | |
| | | | Impinging agitation treatment | | | | | — |
| | | | (microfluidizer) | | | | | |
| | | | Mass ratio (A):(B) in emulsified | 1:0.95 | 1:1.1 | 1:1 | 1:0.15 | 1:1 |
| | | | mixture | | | | | |
| | | | Particle diameter of emulsified | 390 | 370 | 500 | 1,780 | >10,000 |
| | | | mixture (nm) | | | | | |
| | Desolventization | Distill of | Amounts of distilled | 133 | 130 | 130 | — | — |
| | step | solvent after | organic solvent | | | | | |
| | | emulsificatio [symbol] | (Desolvation amount (g)) | | | | | |

| | | | | | | |
|---|---|---|---|---|---|---|
| Evaluation | Average particle diameler of silicone resin emulsion for preparing a | 390 | 385 | 495 | 1,780 | >10,000 |
| | coating composition (nm) | | | | | |
| | State of silicone resin emulsion for preparing a coating composition | ◯ | ◯ | ◯ | X | X |
| | Odor | ◯ | ◯ | ◯ | ◯ | X |
| | Flash point (° C.) | >80 | >80 | >80 | — | — |
| | Residual amount of organic solvent (%) | <0.1 | <0.1 | <0.1 | — | — |
| | Strage stability | ◯ | ◯ | ◯ | X | X |

| | | | | | Com. Ex. 1-3 | Com. Ex. 1-4 | Com. Ex. 1-5 |
|---|---|---|---|---|---|---|---|
| | | | | Weight average | | | |
| | | Type | Structure | molecular weight | | | |
| Emulsified | Silicone | (A1-1) | Branched | 20,000 | 100 | 100 | 100 |
| mixture | resin (A) | (A1-2) | Branched | 40,000 | | | |
| | | (A1-3) | Branched | 5,000 | | | |
| | | (A2-2) | Liner | 4,000 | | | |
| | | (A1-4) | Branched | 900 | | | |
| | | | | Solubility in water | | | |
| | | Type | Name | (g/100 gH₂O) | | | |
| | Organic | (B-1) | Toluene | 0.047 | 100 | 100 | 100 |
| | solvent (B) | (B-2) | Xylene | 0 | | | |
| | | (B-3) | Cactus | 0.04 | | | 150 |
| | | | Solvent P-150 | | | | |
| | | (b-1) | Butoxy- | 5.5 | 100 | | |
| | | | propanol | | | | |
| | | Type | Structure | | | | |
| | Emulsifier | (C-1) | Anion | | 5 | 5 | 5 |
| | (C) | (C-2) | Anion | | | | |
| | | (C-3) | Nonion | | | | |
| | Aqueous | Ion | | | 172 | 113 | 322 |
| | medium | exchanged | | | | | |

| | | | | | | |
|---|---|---|---|---|---|---|
| Step | Desolventization | Distill of | Amounts of distilled organic | 100 | | |
| | step | solvent | solvent | | | |
| | | before | (Desolvation amount (g)) | | | |
| | | emulsificatio [symbol] | | | | |
| | Before | | Mass ratio (A):(B) before mechanical | 1:0 | 1:1 | 1:2.5 |
| | emulsification | | emulsification treatment (A):(B) | | | |
| | step | | Viscosity of mixture (A) + (B) before | 17 | 15 | 8 |
| | | | mechanical emulsification treatment | | | |
| | | | (mPa · s) | | | |
| | After | Mechanical | Shear force | 35 MPa | 35 MPa | 35 MPa |
| | emuisification | emulsification | High speed rotary agitation treatment | | | |
| | step | treatment | (disper stirring) | | | |
| | | | Counter impinging treatment (high | ● | ● | ● |
| | | | presurred homogeniser) | | | |
| | | | Impinging agitation treatment | | | |
| | | | (microfluidizer) | | | |
| | | | Mass ratio (A):(B) in emulsified | 1:0 | 1:1 | 1:2.5 |
| | | | mixture | | | |
| | | | Particle diameter of emulsified | 320 | 360 | 330 |
| | | | mixture (nm) | | | |
| | Desolventization | Distill of | Amounts of distilled organic | 130 | — | 280 |
| | step | solvent after | solvent | | | |
| | | emulsificatio [symbol] | (Desolvation amount (g)) | | | |

| | | | | |
|---|---|---|---|---|
| Evaluation | Average particle diameler of silicone resin emulsion | 315 | 360 | 310 |
| | for preparing a coating composition (nm) | | | |
| | State of silicone resin emulsion for preparing a coating composition | ◯ | ◯ | ◯ |
| | Odor | ◯Δ | X | Δ |
| | Flash point (° C.) | — | 10-15 | 70 |
| | Residual amount of organic solvent (%) | — | 31.4 | <0.1 |
| | Strage stability | X | ◯ | ◯ |

[symbol]

indicates data missing or illegible when filed

In all of the silicone resin emulsions prepared in Examples, the average particle diameter was in a range of 100 to 500 nm, and the storage stability was good.

Comparative Example 1-1 is an example in which the organic solvent (B) was removed before the execution of emulsification and both the branched organopolysiloxane (A1) and the linear organopolysiloxane are contained as the silicone resin (A). The silicone resin emulsion prepared in this example had an average particle diameter greater than 500 nm and was poor in storage stability.

Comparative Example 1-2 is an example in which the preparation was conducted by the same procedure as in Example 1-1 except that a disper was used in place of the high pressure homogenizer and that there was no desolventization step. The silicone resin emulsion prepared in this example had an average particle diameter greater than 500 nm and was poor in storage stability.

Comparative Example 1-3 is an example in which the preparation was conducted by using an organic solvent having a solubility in water of greater than 1 g/100 g-H₂O as an organic solvent and removing the organic solvent (B) and replacing it by butoxypropanol (b-1) before the execution of emulsification. In this example, a large amount of hydrophilic organic solvent remained after the desolventization step and the storage stability was poor.

Comparative Example 1-4 is an example in which the preparation was conducted in the same manner as in Example 1-1 except that there was no desolventization step. The silicone resin emulsion prepared in this example was not suitable as an emulsion for preparing an aqueous coating composition because it has a strong solvent odor and has a flash point and needs to be handled as a hazardous material.

Comparative Example 1-5 is an example in which the preparation was conducted by the same procedure as in Example 1-1 except that 150 parts by mass of the organic solvent (B-3) was added before the execution of emulsification. The silicone resin emulsion prepared in this example had a slight odor and had a lower flash point than in Examples. Furthermore, since a large amount of solvent was removed in the desolventization step, it took time for the desolventization step.

### Production of Aqueous Coating Composition

40 parts by mass of the silicone resin emulsion obtained in Example 1-1, 0.15 parts by mass of 25% ammonia water and 37 parts by mass of tap water were mixed. Next, 1.23 parts by mass of DIBUTYL TIN OXIDE (produced by Nitto Kasei Co., Ltd.) was added as a curing catalyst and was mixed. Furthermore, 2 parts by mass of Primal ASE-60 (produced by The Dow Chemical Company) was added as an alkali swelling type thickener and was mixed to obtain an aqueous silicone coating composition. The obtained aqueous silicone coating composition was spray coated and was dried at 160° C. for 3 minutes to obtain a silicone coating film.

### Reference Example 1-1

Preparation of Silicone Resin Emulsion using Silicone Resin (A) Containing No Branched Organopolysiloxane (A1), and Preparation of Aqueous Coating Composition

A silicone resin emulsion was prepared in the same manner as in Example 1 except that only 100 parts by mass of YF-3800 (produced by Momentive, linear organopolysiloxane), the silicone resin (A2-2), was used as silicone resin (A). The obtained silicone resin emulsion had an average particle diameter of 360 nm.

Using the obtained silicone resin emulsion, an aqueous silicone coating composition was obtained in the same manner as described above.

When the obtained aqueous silicone coating composition was spray coated and was dried at 160° C. for 3 minutes, the formation of a coating film was confirmed, but it was confirmed that the formed coating film was low in toughness and failed to have performance high enough for practical use. From these results, it is understood that the silicone resin emulsion is not suitable as an emulsion for preparing a coating composition.

### 2. Examples and Comparative Examples of Aqueous Coating Composition Containing Silicone Resin Emulsion

### Production Example 2-1

Production of silicone resin emulsion (S1-1)

In a stainless steel container were mixed 140 parts by mass of SR-2400 (produced by Dow Corning Toray Silicone Co., Ltd., branched organopolysiloxane; weight average molecular weight: 20,000, viscosity: 15 mPa·s, solid concentration: 50% by mass, organic solvent (B-1): toluene) as silicone resin (A1-1) and 30 parts by mass of XC96-723 (produced by Momentive Performance Materials Inc., linear organopolysiloxane; weight average molecular weight: 2,200, viscosity: 30 mPa·s, solid concentration: 100% by mass) as silicone resin (A2-1). The obtained mixture had a viscosity of 20 mPa·s.

To another stainless steel container were added 25 parts by mass of LATEMUL PD-104 (produced by Kao Corporation, anionic emulsifier; content of components: 20% by mass) as emulsifier (C-1) and 182 parts by mass of ion-exchanged water, 170 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 (produced by San Nopco Ltd., defoamer) was added and was treated at 35 MPa using a high pressure homogenizer H20-H2 (manufactured by Sanwa Engineering Co., Ltd.) (mechanical emulsification treatment; emulsification step), and thus 377 parts by mass of an emulsified mixture was obtained.

Furthermore, the emulsion was heated to 55° C. and desolventized under reduced pressure, so that the organic solvent (B-1) was distilled off together with water (desolventization step), and thus 244 parts by mass of silicone resin emulsion (S1-1) (solid concentration: 43% by mass) was obtained.

The obtained silicone resin emulsion (S1-1) had an average particle diameter of 350 nm. Further, the content of the organic solvent (toluene (B-1)) in the obtained silicone resin emulsion was measured to be less than 0.1%.

### Production Example 2-2

### Production of Silicone Resin Emulsion (S1-2)

In a stainless steel container were mixed 140 parts by mass of silicone resin (A1-1) and 30 parts by mass of YF-3800 (produced by Momentive Performance Materials Inc., linear organopolysiloxane; weight average molecular weight: 4,000, viscosity: 70 mPa·s, solid concentration: 100% by mass) as silicone resin (A2-2). The obtained mixture had a viscosity of 51 mPa·s.

To another stainless steel container were added 25 parts by mass of emulsifier (C-1) and 182 parts by mass of ion-exchanged water, 170 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2, and thus 377 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion (S1-2) (solid concentration: 43% by mass) was obtained.

The obtained silicone resin emulsion (S1-2) had an average particle diameter of 350 nm.

### Production Example 2-3

### Production of Silicone Resin Emulsion (S1-3)

In a stainless steel container were mixed 140 parts by mass of silicone resin (A1-1) and 30 parts by mass of XF-3905 (produced by Momentive Performance Materials Inc., linear organopolysiloxane; weight average molecular weight: 20,000, viscosity: 700 mPa·s, solid concentration: 100% by mass) as silicone resin (A2-3). The obtained mixture had a viscosity of 200 mPa·s.

To another stainless steel container were added 25 parts by mass of emulsifier (C-1) and 182 parts by mass of ion-exchanged water, 170 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2, and thus 377 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion (S1-3) (solid concentration: 43% by mass) was obtained.

The obtained silicone resin emulsion (S1-3) had an average particle diameter of 370 nm.

### Production Example 2-4

### Production of Silicone Resin Emulsion (S1-4)

In a stainless steel container were mixed 190 parts by mass of silicone resin (A1-1) and 5 parts by mass of silicone resin (A2-2). The obtained mixture had a viscosity of 17 mPa·s.

To another stainless steel container were added 25 parts by mass of emulsifier (C-1) and 182 parts by mass of ion-exchanged water, 195 parts by mass of the above mixture was added with stirring, and the mixture was stirred at 1,500 rpm for 15 minutes using a disper (total quantity: 402 parts by mass, solid content: 105 parts by mass).

Subsequently, 0.057 parts by mass of SN-777 was added and then was treated at 35 MPa using a high pressure homogenizer H20-H2, and thus 402 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion (S1-4) (solid concentration: 43% by mass) was obtained.

The obtained silicone resin emulsion (S1-4) had an average particle diameter of 320 nm.

### Production Example 2-5

Production of silicone resin emulsion (S1-5)

In a stainless steel container were mixed 170 parts by mass of silicone resin (A1-1) and 15 parts by mass of silicone resin (A2-2). The obtained mixture had a viscosity of 30 mPa·s.

To another stainless steel container were added 25 parts by mass of emulsifier (C-1) and 182 parts by mass of ion-exchanged water, 185 parts by mass of the above mixture was added with stirring, and the mixture was stirred at 1,500 rpm for 15 minutes using a disper (total quantity: 392 parts by mass, solid content: 105 parts by mass).

Subsequently, 0.057 parts by mass of SN-777 was added and then was treated at 35 MPa using a high pressure homogenizer H20-H2, and thus 392 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion (S1-5) (solid concentration: 43% by mass) was obtained.

The obtained silicone resin emulsion (S1-5) had an average particle diameter of 330 nm.

### Production Example 2-6

### Production of Silicone Resin Emulsion (S1-6)

In a stainless steel container were mixed 100 parts by mass of silicone resin (A1-1) and 50 parts by mass of silicone resin (A2-2). The obtained mixture had a viscosity of 58 mPa·s.

To another stainless steel container were added 25 parts by mass of emulsifier (C-1) and 182 parts by mass of ion-exchanged water, 150 parts by mass of the above mixture was added with stirring, and the mixture was stirred at 1,500 rpm for 15 minutes using a disper (total quantity: 357 parts by mass, solid content: 105 parts by mass).

Subsequently, 0.057 parts by mass of SN-777 was added and then was treated at 35 MPa using a high pressure homogenizer H20-H2, and thus 357 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion (S1-6) (solid concentration: 43% by mass) was obtained.

The obtained silicone resin emulsion (S1-6) had an average particle diameter of 370 nm.

### Production Example 2-7

### Production of Silicone Resin Emulsion (S1-7)

In a stainless steel container were mixed 175 parts by mass of X40-2406M (produced by Shin-Etsu Chemical Co., Ltd., branched organopolysiloxane; weight average molecular weight: 40,000, viscosity: 20 mPa·s, solid concentration: 40% by mass, organic solvent (B-2): xylene) as silicone resin (A1-2) and 30 parts by mass of silicone resin (A2-2). The obtained mixture had a viscosity of 55 mPa·s.

To another stainless steel container were added 25 parts by mass of emulsifier (C-1) and 182 parts by mass of ion-exchanged water, 205 parts by mass of the above mixture was added with stirring, and the mixture was stirred at 1,500 rpm for 15 minutes using a disper (total quantity: 412 parts by mass, solid content: 105 parts by mass).

Subsequently, 0.057 parts by mass of SN-777 was added and then was treated at 35 MPa using a high pressure homogenizer H20-H2, and thus 412 parts by mass of an emulsified mixture was obtained.

Furthermore, the emulsion was heated to 55° C. and desolventized under reduced pressure, so that the organic solvent (B-2) was distilled off together with water, and thus 244 parts by mass of silicone resin emulsion (S1-7) (solid concentration: 43% by mass) was obtained.

The obtained silicone resin emulsion (S1-7) had an average particle diameter of 340 nm.

### Production Example 2-8

### Production of Silicone Resin Emulsion (S1-8)

In a stainless steel container were mixed 117 parts by mass of 804 RESIN (produced by Dow Corning Toray Silicone Co., Ltd., branched organopolysiloxane; weight average molecular weight: 5,000, viscosity: 30 mPa·s, solid concentration: 60% by mass, organic solvent (B-1): toluene) as silicone resin (A1-3) and 30 parts by mass of silicone resin (A2-2). The obtained mixture had a viscosity of 57 mPa·s.

To another stainless steel container were added 25 parts by mass of emulsifier (C-1) and 182 parts by mass of ion-exchanged water, 147 parts by mass of the above mixture was added with stirring, and the mixture was stirred at 1,500 rpm for 15 minutes using a disper (total quantity: 354 parts by mass, solid content: 105 parts by mass).

Subsequently, 0.057 parts by mass of SN-777 was added and then was treated at 35 MPa using a high pressure homogenizer H20-H2, and thus 354 parts by mass of an emulsified mixture was obtained. Furthermore, the emulsion was heated to 55° C. and desolventized under reduced pressure, so that the organic solvent (B-1) was distilled off together with water, and thus 244 parts by mass of silicone resin emulsion (S1-8) (solid concentration: 43% by mass) was obtained.

The obtained silicone resin emulsion (S1-8) had an average particle diameter of 350 nm.

### Production Example 2-9

### Production of Silicone Resin Emulsion (S2-1)

To a stainless steel container were added 25 parts by mass of emulsifier (C-1) and 152 parts by mass of ion-exchanged water, 200 parts by mass of silicone resin (A1-1) was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2, and thus 377 parts by mass of an emulsified mixture was obtained.

Furthermore, the emulsified mixture was heated to 55° C. and desolventized under reduced pressure, so that the organic solvent (B-1) was distilled off together with water, and thus 244 parts by mass of silicone resin emulsion (S2-1) (solid concentration: 43% by mass) was obtained. The obtained silicone resin emulsion (S2-1) had an average particle diameter of 345 nm.

### Production Example 2-10

### Production of Silicone Resin Emulsion (S3-1)

To a stainless steel container were added 25 parts by mass of emulsifier (C-1) and 119 parts by mass of ion-exchanged water, 100 parts by mass of silicone resin (A2-2) was added with stirring, and the mixture was stirred at 1,500 rpm for 15 minutes using a disper (total quantity: 244 parts by mass, solid content: 105 parts by mass).

Subsequently, 0.057 parts by mass of SN-777 was added and then was treated at 35 MPa using a high pressure homogenizer H20-H2, and thus 244 parts by mass of emulsion (S3-1) was obtained.

The obtained emulsion (S3-1) had an average particle diameter of 320 nm.

### Production Example 2-11

### Production of Silicone Resin Emulsion (S1-9)

In a stainless steel container were mixed 140 parts by mass of silicone resin (A1-1), 30 parts by mass of silicone resin (A2-2) and 40 parts by mass of Cactus Solvent P-150 (produced by JXTG Nippon Oil & Energy Corporation) as organic solvent (B-3), and thus 210 parts by mass of a mixture was obtained. The obtained mixture had a viscosity of 30 mPa·s.

To another stainless steel container were added 25 parts by mass of emulsifier (C-1) and 142 parts by mass of ion-exchanged water, 210 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2 (manufactured by Sanwa Engineering Co., Ltd.), and thus 377 parts by mass of an emulsified mixture was obtained.

Furthermore, the emulsion was heated to 55° C. and desolventized under reduced pressure, so that the organic solvent (B-1) was distilled off together with water, and thus 247 parts by mass of emulsion (S1-9) (solid concentration: 42% by mass) was obtained.

The obtained emulsion (S1-9) had an average particle diameter of 385 nm.

### Production Example 2-12

### Production of Silicone Resin Emulsion (S1-10)

In a stainless steel container were mixed 140 parts by mass of silicone resin (A1-1) and 30 parts by mass of silicone resin (A2-2), and thus 170 parts by mass of a mixture was obtained. The obtained mixture had a viscosity of 51 mPa·s.

To another stainless steel container were added 10 parts by mass of emulsifier (C-1), 3 parts by mass of LATEMUL PD-430 (produced by Kao Corporation, nonionic; content of components: 100% by mass) as emulsifier (C-3), and 194 parts by mass of ion-exchanged water, 170 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2, and thus 377 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion (S1-10) (solid concentration: 43% by mass) was obtained.

The obtained silicone resin emulsion (S1-10) had an average particle diameter of 365 nm.

### Production Example 2-13

Production of Silicone Resin Emulsion (s1-1)

In a stainless steel container were mixed 140 parts by mass of silicone resin (A1-1) and 30 parts by mass of YF-3057 (produced by Momentive Performance Materials Inc., linear organopolysiloxane; weight average molecular weight: 33,000, viscosity: 3,000 mPa·s, solid concentration: 100% by mass) as silicone resin (A2-4). The obtained mixture had a viscosity of 600 mPa·s.

To another stainless steel container were added 25 parts by mass of emulsifier (C-1) and 182 parts by mass of ion-exchanged water, 170 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2, and thus 377 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion (s1-1) (solid concentration: 43% by mass) was obtained.

The obtained silicone resin emulsion (s1-1) had an average particle diameter of 370 nm.

### Production Example 2-14

Production of Silicone Resin Emulsion (s1-2)

In a stainless steel container were mixed 140 parts by mass of silicone resin (A1-1) and 30 parts by mass of XF-3802 (produced by Momentive Performance Materials Inc., linear organopolysiloxane; weight average molecular weight: 100,000, viscosity: 80,000 mPa·s, solid concentration: 100% by mass) as silicone resin (A2-5). The obtained mixture had a viscosity of 2,000 mPa·s.

To another stainless steel container were added 25 parts by mass of emulsifier (C-1) and 182 parts by mass of ion-exchanged water, 170 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2, and thus 377 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion (s1-2) (solid concentration: 43% by mass) was obtained.

The obtained silicone resin emulsion (s1-2) had an average particle diameter of 390 nm.

### Production Example 2-15

Production of Silicone Resin Emulsion (s1-3)

In a stainless steel container equipped with a desolventization device were mixed 140 parts by mass of silicone resin (A1-1) and 30 parts by mass of silicone resin (A2-2), and thus 170 parts by mass of a mixture was obtained. The obtained mixture was heated to 75° C. and desolventized under reduced pressure, so that 70 parts by mass of organic solvent (B-1) was distilled off. The mixture had a viscosity of 6,000 mPa·s.

To another stainless steel container were added 25 parts by mass of emulsifier (C-1) and 119 parts by mass of ion-exchanged water, 100 parts by mass of the above mixture was added with stirring, and the mixture was stirred at 1,500 rpm for 15 minutes using a disper (total quantity: 244 parts by mass, solid content: 105 parts by mass).

Subsequently, 0.057 parts by mass of SN-777 was added and then was treated at 35 MPa using a high pressure homogenizer H20-H2, and thus 244 parts by mass (solid concentration: 43% by mass) of silicone resin emulsion (s1-3) was obtained.

The obtained silicone resin emulsion (s1-3) had an average particle diameter of 2,500 nm. When the silicone resin emulsion (s1-3) was allowed to stand for 1 day, separation and sedimentation occurred.

### Production Example 2-16

Production of Silicone Resin Emulsion (s1-4)

In a stainless steel container equipped with a desolventization device were mixed 140 parts by mass of silicone resin (A1-1), 30 parts by mass of silicone resin (A2-2) and 100 parts by mass of butoxypropanol as organic solvent (b-1), and thus 270 parts by mass of a mixture was obtained. The obtained mixture was heated to 75° C. and desolventized under reduced pressure, so that 70 parts by mass of organic solvent (B-1) was distilled off, and thus 200 parts by mass of a resin mixture containing only (b-1) as an organic solvent was obtained. The mixture had a viscosity of 15 mPa·s.

To another stainless steel container were added 25 parts by mass of emulsifier (C-1) and 152 parts by mass of ion-exchanged water, 200 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2, and thus 377 parts by mass (solid content: 105 parts by mass) of an emulsified mixture was obtained.

Furthermore, the emulsion was heated to 55° C. and desolventized under reduced pressure, so that 133 parts by mass in total of water and organic solvent (b-1) were distilled off, and thus 244 parts by mass of silicone resin emulsion (s1-4) (solid concentration: 43% by mass) was obtained.

While the obtained silicone resin emulsion (s1-4) had an average particle diameter of 315 nm, separation and sedimentation occurred when it was allowed to stand for 30 days.

### Production Example 2-17

Production of Silicone Resin Emulsion (s1-5)

To a stainless steel container were added 25 parts by mass of emulsifier (C-1) and 93 parts by mass of ion-exchanged water, a mixture of 140 parts by mass of silicone resin (A1-1) and 30 parts by mass of silicone resin (A2-2) prepared in advance was added with stirring at 1,500 rpm, and the resultant was stirred for 15 minutes (total quantity: 288 parts by mass, solid content: 105 parts by mass).

The obtained silicone resin emulsion (s1-5) had an average particle diameter of 10,000 nm or more. In addition, when the silicone resin emulsion (s1-5) was allowed to stand for 1 day, separation and sedimentation occurred.

### Production Example 2-18

Production of Silicone Resin Emulsion (s1-6)

In a stainless steel container were mixed 70 parts by mass of KR-220LP (produced by Shin-Etsu Chemical Co., Ltd., branched organopolysiloxane weight average molecular weight: 900, solid concentration: 100% by mass) as silicone resin (A1-4), 30 parts by mass of silicone resin (A2-2) and 70 parts by mass of organic solvent (B-1). The obtained mixture had a viscosity of 20 mPa·s.

To another stainless steel container were added 25 parts by mass of emulsifier (C-1) and 182 parts by mass of ion-exchanged water, 170 parts by mass of the above mixture was added with stirring, and the mixture was stirred at 1,500 rpm for 15 minutes using a disper (total quantity: 377 parts by mass, solid content: 105 parts by mass).

Subsequently, 0.057 parts by mass of SN-777 was added and then was treated at 35 MPa using a high pressure homogenizer H20-H2, and thus 377 parts by mass of an emulsified mixture was obtained.

Furthermore, the emulsion was heated to 55° C. and desolventized under reduced pressure, so that the organic solvent (B-1) was distilled off together with water, and thus 244 parts by mass of silicone resin emulsion (s1-6) (solid concentration: 43% by mass) was obtained.

The obtained silicone resin emulsion (s1-6) had an average particle diameter of 330 nm.

In the above Production Examples, emulsions obtained by emulsifying a mixture of branched organopolysiloxane (A1) and linear organopolysiloxane (A2) are denoted as (S1), emulsions obtained by emulsifying branched organopolysiloxane (A1) are denoted as (S2), and emulsions obtained by emulsifying linear organopolysiloxane (A2) are denoted as (S3). In addition, the emulsions used in Comparative Examples are denoted as (s1).

The silicone resins (A) used in the respective Production Examples are as shown in the following table.

TABLE 3

| | | | | | | | Solid |
|---|---|---|---|---|---|---|---|
| Silicone | Product | | Structure of | Weight average | | | concentration |
| resin (A) | name | Manufacturer's name | organopolysiloxan | molecular weight | m/n | Solvent (B) | (%) |
| (A1-1) | SR-2400 | Dow Corning Toray Silicone | Branched | 20,000 | 180/60 | Toluene | 50 |
| | | Co., Ltd. | | | | (B-1) | |
| (A1-2) | X40-2406M | Shin-Etsu Chemical Co., Ltd. | Branched | 40,000 | 510/80 | Xylene | 40 |
| | | | | | | (B-2) | |
| (A1-3) | 804 RESIN | Dow Corning Toray Silicone | Branched | 5,000 | 60/20 | Toluene | 60 |
| | | Co., Ltd. | | | | (B-1) | |
| (A1-4) | KR-220LP | Shin-Etsu Chemical Co., Ltd. | Branched | 900 | 15/0 | — | 100 |
| (A2-1) | XC96-723 | Momentive Performance | Liner | 2,200 | — | — | 100 |
| | | Materials Inc. | | | | | |
| (A2-2) | YF-3800 | Momentive Performance | Liner | 4,000 | — | — | 100 |
| | | Materials Inc. | | | | | |
| (A2-3) | XF-3905 | Momentive Performance | Liner | 20,000 | — | — | 100 |
| | | Materials Inc. | | | | | |
| (A2-4) | YF-3057 | Momentive Performance | Liner | 33,000 | — | — | 100 |
| | | Materials Inc. | | | | | |
| (A2-5) | YF-3802 | Momentive Performance | Liner | 100,000 | — | — | 100 |
| | | Materials Inc. | | | | | |

The m/n value of the silicone resins (A) was calculated from the weight average molecular weight measured by a gel permeation chromatograph HLC-8220GPC (manufactured by Tosoh Corporation) and the compositional ratio of R¹SiO_{3/2} and R²₂SiO determined from 29Si-NMR DPX400 (manufactured by Bruker).

The viscosity of the mixture before mechanical emulsification treatment containing the silicone resin (A) and the organic solvent (B) was measured with a TVB-10 type viscometer (TVB-10H, manufactured by Toki Sangyo Co., Ltd.; measurement temperature: 25° C., rotation speed: 60 rpm).

The average particle diameter of the silicone resin emulsions (S) obtained in the above Production Examples was measured using an electrophoretic light scattering photometer ELSZ (manufactured by Otsuka Electronics Co., Ltd.) by diluting their aqueous dispersions with deionized water so that the signal level became appropriate.

The residual amount of toluene (B-1) or xylene (B-2) contained in the silicone resins obtained by the above Production Examples was measured using a gas chromatograph GC-2014 (manufactured by Shimadzu Corporation).

The odor of the silicone resin emulsions obtained in the above Production Examples was evaluated according to the following criteria.
◯: No odor is felt.
Δ: Odor is felt slightly.
×: Odor is felt obviously.

The organic solvents (B) and the emulsifiers (C) used in the respective Production Examples are as follows.
Organic solvent (B-1): toluene (azeotropic point with water: 85° C., solubility in water: 0.047 g/100 g-H₂O)
Organic solvent (B-2): xylene (azeotropic point with water: 94.5° C., solubility in water: 0 g/100 g-H₂O)
Organic solvent (B-3): Cactus Solvent P-150 (manufactured by JXTG Nippon Oil & Energy Corporation, azeotropic point with water: no, solubility in water: 0.04 g/100 g-H₂O)
Organic solvent (b-1): butoxypropanol (azeotropic point with water: no, solubility in water: 5.5 g/100 g-H₂O)
Emulsifier (C-1): LATEMUL PD-104 (produced by Kao Corporation, anionic, content of components: 20% by mass)
Emulsifier (C-3): LATEMUL PD-430 (produced by Kao Corporation, nonionic, content of components: 100% by mass)

### Example 2-1

### Preparation of Aqueous Coating Composition

40 parts by mass of the obtained silicone resin emulsion (S1-1) and 37 parts by mass of tap water were mixed, and 0.15 parts by mass of ammonia water was added to and mixed with the mixed aqueous solution. Next, 2 parts by mass of Primal ASE60 (produced by The Dow Chemical Company) was added as an alkali swelling type thickener, and 1.23 parts by mass of DIBUTYL TIN OXIDE (produced by Nitto Kasei Co., Ltd.) as a curing catalyst was added and mixed, and thus an aqueous coating composition was obtained.

### Examples 2-2 to 2-8, 2-10, 2-11 and Comparative Examples 2-1 to 2-7

Aqueous coating compositions were obtained in the same manner as in Example 1 except that the silicone resin emulsions (S1-2) to (S1-10), (s1-1) to (s1-6), (S2-1) and (S3-1) obtained in the above Production Examples were used.

### Example 2-9

28 parts by mass of the silicone resin emulsion (S2-1), 12 parts by mass of the silicone resin emulsion (S3-1) and 37 parts by mass of tap water were mixed, and 0.15 parts by mass of ammonia water was added to and mixed with the mixture. Next, 2 parts by mass of Primal ASE 60 was added, and 1.23 parts by mass of DIBUTYL TIN OXIDE was further added and mixed, and thus an aqueous coating composition was obtained.

### Examples 2-12

To a pigment paste composed of 2 parts by mass of BYK190 (produced by BYK Chemie), 6.5 parts by mass of TIPAQUE CR-95 (produced by Ishihara Sangyo Kaisha, Ltd., titanium oxide), 6.5 parts by mass of BARIFINE BF-20 (Sakai Chemical Industry Co., Ltd. precipitated barium sulfate) and 5 parts by mass of tap water, 55 parts by mass of the silicone resin emulsion (S1-1) obtained and 0.2 parts by mass of 25% ammonia water were added and mixed. Next, 15.6 parts by mass of tap water was added, 1 part by mass of Primal ASE 60 was added and mixed, and 1.23 parts by mass of DIBUTYL TIN OXIDE was further added and mixed, and thus an aqueous coating composition was obtained.

### Comparative Example 2-8

To a pigment paste composed of 2 parts by mass of BYK 190, 6.5 parts by mass of TIPAQUE CR-95, 6.5 parts by mass of BARIFINE BF-20 and 5 parts by mass of tap water, 55 parts by mass of an acrylic resin emulsion ACRYSET EX-41 (produced by Nippon Shokubai Co., Ltd. solid concentration: 43% by mass) and 0.2 parts by mass of 25% aqueous ammonia were added and mixed. Next, 15.6 parts by mass of tap water was added, 1 part by mass of Primal ASE 60 was added and mixed, 1 part by mass of CS-12 (produced by Chisso Corporation) was further added as a film-forming aid and mixed, and thus an aqueous coating composition was prepared.

The aqueous coating compositions prepared in the above Examples and Comparative Examples were subjected to the following evaluations. The evaluation results obtained are shown in the following tables.

### Preparation of Test Coated Plate

Each of the aqueous coating compositions obtained in the above Examples and Comparative Examples was spray coated on a slate plate to have a wet coating amount of 35 g/m² and then was dried at 160° C. for 3 minutes, and thus a test coated plate with a silicone resin coating film was obtained.

### Paint Stability

Each of the silicone resin emulsions obtained in the above Examples and Comparative Examples was filtered through a 200 mesh filter and then was allowed to stand at 40° C. for 3 months. The state of the silicone resin emulsion after standing was visually observed and the paint stability was evaluated according to the following criteria.
◯: No separation/sedimentation, etc. occurred.
×: Separation/sedimentation occurred.

### Measurement of Gel Fraction

Each of the aqueous coating compositions obtained in Examples and Comparative Examples was applied to an aluminum plate with a bar coater to have a wet coating amount of 35 g/m² and was dried at 160° C. for 3 minutes, and thus a test coated plate with a silicone resin coating film was obtained.

The mass of the obtained test coated plate was measured (initial mass). Next, the test coated plate was wrapped with a metal mesh, immersed in acetone, and allowed to stand at room temperature for 12 hours. Thereafter, the test coated plate was taken out and was dried at 100° C. for 3 hours, and its mass after drying was measured (mass after immersion and drying). A gel fraction (%) was calculated as follows.

Gel fraction=weight after immersion and dry/initial mass×100

### Resistance to Water-Whitening

The obtained test coated plate was immersed in warm water at 60° C. for 24 hours. Thereafter, the test coated plate was taken out and dried at room temperature, and the appearance of the coating film was visually observed and evaluated according to the following criteria.
◯: No change is observed as compared with a non-immersed coated film.
◯Δ: Slight whitening is confirmed as compared with a non-immersed coated film.
Δ: Whitening is confirmed in a part of the coating film and/or a very small blister is observed as compared with a non-immersed coating film.
Δ×: Whitening is confirmed in the whole coating film and/or several small blisters are found as compared with a non-immersed coating film.
×: Remarkable whitening is observed in the entire coating film and/or a large blister is observed as compared with a non-immersed coating film.

### Alkali Resistance

The obtained test coated plate was immersed in a saturated aqueous solution of calcium hydroxide at 23° C. for 5 days. Thereafter, the test coated plate was taken out and dried at room temperature, and the appearance of the coating film was visually observed and evaluated according to the following criteria.
◯: No change is observed as compared with a non-immersed coated film.
◯Δ: Slight whitening is confirmed as compared with a non-immersed coated film.
Δ: Whitening is confirmed in a part of the coating film and/or a very small blister is observed as compared with a non-immersed coating film.
Δ×: Whitening is confirmed in the overall coating film and/or several small blisters are found as compared with a non-immersed coating film.
×: Remarkable whitening is observed in the entire coating film and/or a large blister is observed as compared with a non-immersed coating film.

### Accelerated Weatherability (Evaluation of Coating Film Appearance After Accelerated Weatherability Test)

An accelerated weatherability test was carried out for the above-obtained evaluation test plate using sunshine weatherometer (manufactured by Suga Test Instruments Co., Ltd.) (operating conditions: according to JIS K 5400, operation time: 10,000 hours). The appearance of the coating film of the evaluation test plate after accelerated weatherability test was visually evaluated according to the following criteria.
◯: There is no change.
◯Δ: Slight whitening is observed in the coating film.
Δ: Whitening is observed in a part of the coating film.
Δ×: Whitening and/or cracking is observed in a wide range of the coating film.
×: Remarkable whitening and/or delamination is observed in the entire coating film.

TABLE 4

| | | | | | Exam. 2-1 | Exam. 2-2 | Exam. 2-3 | Exam. 2-4 | Exam. 2-5 | Exam. 2-6 | Exam. 2-7 | Exam. 2-8 | Exam. 2-9 | Exam. 2-10 | Exam. 2-11 |
|---|---|---|---|---|---|---|---|---|---|---|---|---|---|---|---|
| Composition | Silicone resin emulsion (S) used | | | | (S1-1) | (S1-2) | (S1-3) | (S1-4) | (S1-5) | (S1-6) | (S1-7) | (S1-8) | (S2-1) | (S1-9) | (S1-10) |
| | | | | | | | | | | | | | (S3-1) | | |
| | | Silicone resin | Type | Mw | | | | | | | | | | | |
| | Silicone | (A1) | (A1-1) | 20,000 | 70 | 70 | 70 | 95 | 85 | 50 | | | | 70 | 70 |
| | resin | (branched | (A1-2) | 40,000 | | | | | | | 70 | | | | |
| | emulsion | organopoly- | (A1-3) | 5,000 | | | | | | | | 70 | | | |
| | (S1) | siloxane) | (A1-4) | 900 | | | | | | | | | | | |
| | | (A2) | (A2-1) | 2,200 | 30 | | | | | | | | | | |
| | | (liner | (A2-2) | 4,000 | | 30 | | 5 | 15 | 50 | 30 | 30 | | 30 | 30 |
| | | organopoly- | (A2-3) | 20,000 | | | 30 | | | | | | | | |
| | | siloxane) | (A2-4) | 33,000 | | | | | | | | | | | |
| | | | (A2-5) | 100,000 | | | | | | | | | | | |
| | Silicone resin | (A1) | (A1-1) | 20,000 | | | | | | | | | 70 | | |
| | emulsion | (branched | | | | | | | | | | | | | |
| | (S2) | organopoly- | | | | | | | | | | | | | |
| | | siloxane) | | | | | | | | | | | | | |
| | Silicone resin | (A2) | (A2-2) | 4,000 | | | | | | | | | 30 | | |
| | emulsion | (liner | | | | | | | | | | | | | |
| | (S3) | organopoly- | | | | | | | | | | | | | |
| | | siloxane) | | | | | | | | | | | | | |
| | | | | Solubility in water | | | | | | | | | | | |
| | | Name | Type | (g/100 gH₂O) | | | | | | | | | | | |
| | Organic | Toluene | (B-1) | 0.047 | 70 | 70 | 70 | 95 | 85 | 50 | | 47 | 70 | 70 | 70 |
| | solvent (B) | Xylene | (B-2) | 0 | | | | | | | 105 | | | | |
| | | Cactus Solvent | (B-3) | 0.04 | | | | | | | | | | 40 | |
| | | P-150 | | | | | | | | | | | | | |
| | | Butoxy- | (b-1) | 5.5 | | | | | | | | | | | |
| | | propanol | | | | | | | | | | | | | |
| | | Type | Structur | | | | | | | | | | | | |
| | Emulsifier (C) | (C-1) | Anion | | 5 | 5 | 5 | 5 | 5 | 5 | 5 | 5 | 5 | 5 | 2 |
| | | (C-3) | Nonion | | | | | | | | | | | | 3 |
| | Aqueous | Ion exchanged | | | 202 | 202 | 202 | 202 | 202 | 202 | 202 | 202 | 172/139 | 162 | 202 |
| | medium | water | | | | | | | | | | | | | |

| | Mass ratio of (A1), (A2) ((A1:A2)) | | | 70:30 | 70:30 | 70:30 | 95:5 | 85:15 | 50:50 | 70:30 | 70:30 | 70:30 | 70:30 | 70:30 |
|---|---|---|---|---|---|---|---|---|---|---|---|---|---|---|
| Step | Desolventization | Distill of | Amounts of distilled | — | — | — | — | — | — | — | — | — | — | — |
| | step | solvent before | organic solvent | | | | | | | | | | | |
| | | emulsification | (Desolvation amount (g)) | | | | | | | | | | | |
| | Before | Mass ratio (A):(B) before mechanical | | 1:0.7 | 1:0.7 | 1:0.7 | 1:0.85 | 1:0.85 | 1:0.5 | 1:1.05 | 1:0.47 | 1:1 | 1:1.1 | 1:0.7 |
| | emulsification | emulsification treatment | | | | | | | | | | | | |
| | step | Viscosity of mixture containing (A) + (B) | | 20 | 51 | 200 | 17 | 30 | 58 | 55 | 57 | 15 | 30 | 51 |
| | | before mechanical emulsification | | | | | | | | | | | | |
| | Emulsification | Presence (P) or absence (A) of | | P | P | P | P | P | P | P | P | P | P | P |
| | step | mechanincal treatment | | | | | | | | | | | | |
| | | Mass ratio (A):(B) in emulsified mixture | | 1:0.7 | 1:0.7 | 1:0.7 | 1:0.95 | 1:0.85 | 1:0.5 | 1:1.05 | 1:0.47 | 1:1 | 1:1.1 | 1:0.7 |
| | Desolventization | Distill of | Amounts of distilled | 133 | 133 | 133 | 158 | 148 | 113 | 168 | 110 | 133/0 | 133 | 133 |
| | step | solvent after | organic solvent | | | | | | | | | | | |
| | | emulsification | (Desolvation amount (g)) | | | | | | | | | | | |

| | | | | | | | | | | | | |
|---|---|---|---|---|---|---|---|---|---|---|---|---|
| Evaluation | Average particle diameter of of silicone resin emulsion for | 350 | 350 | 370 | 320 | 330 | 370 | 340 | 350 | 345 | 385 | 365 |
| | preparing a coating composition (nm) | | | | | | | | | | | |
| | Odor | ◯ | ◯ | ◯ | ◯ | ◯ | ◯ | ◯ | ◯ | ◯ | ◯ | ◯ |
| | Residual amount of organic solvent (%) | <0.1 | <0.1 | <0.1 | <0.1 | <0.1 | <0.1 | 0.5 | <0.1 | <0.1 | <0.1 | <0.1 |
| | Paint stability | ◯ | ◯ | ◯ | ◯ | ◯ | ◯ | ◯ | ◯ | ◯ | ◯ | ◯ |
| | Gel fraction (%) | 63 | 76 | 63 | 66 | 70 | 65 | 88 | 65 | 75 | 72 | 70 |
| | Resistance to water-whitening | Δ | ◯ | Δ | ◯Δ | ◯ | ◯Δ | ◯Δ | ◯Δ | ◯ | ◯ | ◯ |
| | Alkali resistance | Δ | ◯ | Δ | ◯Δ | ◯ | ◯Δ | ◯Δ | ◯Δ | ◯ | ◯ | ◯ |
| | Accelerated weatherability | ◯Δ | ◯ | ◯Δ | ◯ | ◯ | ◯ | ◯ | ◯Δ | ◯ | ◯ | ◯ |

| | | Com. Ex. 2-1 | Com. Ex. 2-2 | Com. Ex. 2-3 | Com. Ex. 2-4 | Com. Ex. 2-5 | Com. Ex. 2-6 | Com. Ex. 2-7 |
|---|---|---|---|---|---|---|---|---|
| Composition | Silicone resin emulsion (S) used | (s1-1) | (s1-2) | (S3-1) | (s1-3) | (s1-4) | (s1-5) | (s1-6) |

| | Silicone resin | Type | Mw | | | | | | | |
|---|---|---|---|---|---|---|---|---|---|---|
| Silicone | (A1) | (A1-1) | 20,000 | 70 | 70 | | 70 | 70 | 70 | |
| resin | (branched | (A1-2) | 40,000 | | | | | | | |
| emulsion | organopoly- | (A1-3) | 5,000 | | | | | | | |
| (S1) | siloxane) | (A1-4) | 900 | | | | | | | 70 |
| | (A2) | (A2-1) | 2,200 | | | | | | | |
| | (liner | (A2-2) | 4,000 | | | | 30 | 30 | 30 | 30 |
| | organopoly- | (A2-3) | 20,000 | | | | | | | |
| | siloxane) | (A2-4) | 33,000 | 30 | | | | | | |
| | | (A2-5) | 100,000 | | 30 | | | | | |
| Silicone resin | (A1) | (A1-1) | 20,000 | | | | | | | |
| emulsion | (branched | | | | | | | | | |
| (S2) | organopoly- | | | | | | | | | |
| | siloxane) | | | | | | | | | |
| Silicone resin | (A2) | (A2-2) | 4,000 | | | 100 | | | | |
| emulsion | (liner | | | | | | | | | |
| (S3) | organopoly- | | | | | | | | | |
| | siloxane) | | | | | | | | | |
| | | | Solubility in water | | | | | | | |
| | Name | Type | (g/100 gH₂O) | | | | | | | |
| Organic | Toluene | (B-1) | 0.047 | 70 | 70 | | 70 | 70 | 70 | 70 |
| solvent (B) | Xylene | (B-2) | 0 | | | | | | | |
| | Cactus Solvent | (B-3) | 0.04 | | | | | | | |
| | P-150 | | | | | | | | | |
| | Butoxy- | (b-1) | 5.5 | | | | | 100 | | |
| | propanol | | | | | | | | | |
| | Type | Structur | | | | | | | | |
| Emulsifier (C) | (C-1) | Anion | | 5 | 5 | 5 | 5 | 5 | 5 | 5 |
| | (C-3) | Nonion | | | | | | | | |
| Aqueous | Ion exchanged | | | 202 | 202 | 139 | 139 | 172 | 113 | 202 |
| medium | water | | | | | | | | | |

| | Mass ratio of (A1), (A2) ((A1:A2)) | | | 70:30 | 70:30 | 0:100 | 70:30 | 70:30 | 70:30 | 70:30 |
|---|---|---|---|---|---|---|---|---|---|---|
| Step | Desolventization | Distill of | Amounts of distilled | — | — | — | 70 | 70 | — | — |
| | step | solvent before | organic solvent | | | | | | | |
| | | emulsification | (Desolvation amount (g)) | | | | | | | |

| Before | Mass ratio (A):(B) before mechanical | | 1:0.7 | 1:0.7 | 1:0 | 1:0 | 1:0 | 1:0.7 | 1:0.7 |
|---|---|---|---|---|---|---|---|---|---|
| emulsification | emulsification treatment | | | | | | | | |
| step | Viscosity of mixture containing (A) + (B) | | 600 | 2,000 | 30 | 6,000 | 15 | 51 | 20 |
| | before mechanical emulsification | | | | | | | | |
| Emulsification | Presence (P) or absence (A) of | | P | P | P | P | P | A | P |
| step | mechanincal treatment | | | | | | | | |
| | Mass ratio (A):(B) in emulsified mixture | | 1:0.7 | 1:0.7 | 1:0 | 1:0 | 1:0 | 1:0.7 | 1:0.7 |
| Desolventization | Distill of | Amounts of distilled | 133 | 133 | — | — | 133 | — | 133 |
| step | solvent after | organic solvent | | | | | | | |
| | emulsification | (Desolvation amount (g)) | | | | | | | |

| | | | | | | | | |
|---|---|---|---|---|---|---|---|---|
| Evaluation | Average particle diameter of of silicone resin emulsion for | 370 | 390 | 320 | 2,500 | 315 | >10,000 | 330 |
| | preparing a coating composition (nm) | | | | | | | |
| | Odor | ◯ | ◯ | ◯ | ◯ | Δ | X | ◯ |
| | Residual amount of organic solvent (%) | <0.1 | <0.1 | 0 | <0.1 | <0.1 | 24.3 | <0.1 |
| | Paint stability | ◯ | ◯ | ◯ | X | X | X | ◯ |
| | Gel fraction (%) | 58 | 53 | 19 | — | — | — | 55 |
| | Resistance to water-whitening | X | X | X | — | — | — | ΔX |
| | Alkali resistance | Δ | X | X | — | — | — | ΔX |
| | Accelerated weatherability | X | X | X | — | — | — | X |

TABLE 5

| | | | | | Exam. 2-12 | Com. Ex. 2-8 |
|---|---|---|---|---|---|---|
| Composition | Silicone resin emulsion (S) | | | | (S1-1) | — |
| | | Silicone resin | Type | Mw | | |
| | Silicone | (A1) | (A1-1) | 20,000 | 70 | |
| | resin | (branched | | | | |
| | emulsion | organopoly- | | | | |
| | (S1) | siloxane) | | | | |
| | | (A2) | (A2-1) | 2,200 | 30 | |
| | | (liner | | | | |
| | | organopoly- | | | | |
| | Acrylic resin emulsion | | | | | 100 |
| | | | | Solubility in water | | |
| | | Name | Type | (g/100 gH₂O) | | |
| | Organic | Toluene | (B-1) | 0.047 | 70 | — |
| | solvent (B) | | | | | |
| | | Type | Structure | | | |
| | Emulsifier (C) | (C-1) | Anion | | 5 | |
| | Aqueous | Ion exchanged | | | 202 | |
| | medium | water | | | | |

| | Mass ratio of (A1), (A2) ((A1:A2)) | | | 70:30 | |
|---|---|---|---|---|---|
| Step | Desolventization | Distill of solvent | Amounts of distilled organic | — | — |
| | step | before | solvent (Desolvation amount (g)) | | |
| | Before | Mass ratio (A):(B) before mechanical | | 1:0.7 | — |
| | emulsification | emulsification treatment | | | |
| | step | Viscosity of mixture containing (A) + (B) before | | 20 | — |
| | | mechanical emulsification treatment (mPa · s) | | | |
| | emulsification | Presence (P) or absence (A) of mechanical | | P | — |
| | step | treatment | | | |
| | | Mass ratio (A):(B) in emulsified mixture | | 1:0.7 | — |
| | Desolventization | Distill of solvent | Amounts of distilled organic | 133 | — |
| | step | after | solvent (Desolvation | | |
| | | emulsification | amount (g)) | | |

| | | | |
|---|---|---|---|
| Evaluation | Average particle diameter of of silicone resin emulsion for | 350 | 95 |
| | preparing a coating composition (nm) | | |
| | Odor | ◯ | ◯ |
| | Residual amount of organic solvent (%) | <0.1 | — |
| | Paint stability | ◯ | ◯ |
| | Gel fraction (%) | 72.5 | — |
| | Resistance to water-whitening | ◯ | ◯ |
| | Alkali resistance | ◯ | ◯ |
| | Accelerated weatherability | ◯Δ | X |

All the aqueous coating compositions prepared in Examples were superior in paint stability and the obtained coating films were confirmed to be good in water-whitening resistance test (water resistance), alkali resistance test (chemical resistance), and weatherability.

Comparative Examples 2-1 and 2-2 are examples in which the weight average molecular weight of the linear organopolysiloxane (A2) contained in the silicone resin (A) is greater than 30,000. The coating films obtained from the aqueous coating compositions prepared in these examples were confirmed to be insufficient in water resistance and weatherability.

Comparative Example 2-3 is an example in which no branched organopolysiloxane (A1) is contained in the silicone resin (A). The aqueous coating composition prepared in this example was low in gel fraction and the coating film obtained was confirmed to be inferior in water resistance as well as chemical resistance and weatherability.

Comparative Example 2-4 is an example in which desolventization of the organic solvent (B) was performed before emulsification in the preparation of the silicone resin emulsion. The silicone resin emulsion prepared in this example was inferior in storage stability and the aqueous coating composition prepared using this silicone resin emulsion was also confirmed to be inferior in storage stability.

Comparative Example 2-5 is an example in which the organic solvent (b-1) was added before the execution of emulsification and then the organic solvent (B-1) was distilled off and the mass ratio is out of the range of (A):(B)=1:2 to 1:0.2. The silicone resin emulsion prepared in this example was inferior in storage stability and the aqueous coating composition prepared using this silicone resin emulsion was also confirmed to be inferior in storage stability.

Comparative Example 2-6 is an example in which the mechanical emulsification treatment was not performed in the preparation of the silicone resin emulsion. The silicone resin emulsion prepared in this example was inferior in storage stability and the aqueous coating composition prepared using this silicone resin emulsion was also confirmed to be inferior in storage stability. In addition, the silicone resin emulsion prepared in this example emitted an odor, which was clearly felt.

Comparative Example 2-7 is an example in which the weight average molecular weight of the branched organopolysiloxane (A1) is less than 5,000. The coating film obtained from the aqueous coating composition prepared in this example was confirmed to be inferior in water resistance as well as chemical resistance and weatherability.

Comparative Example 2-8 is an example of an enamel coating composition prepared using an acrylic resin emulsion instead of a silicone resin emulsion. The coating film obtained from the coating composition prepared in this example was confirmed to be inferior in weatherability.

### 3. Examples and Comparative Examples of Aqueous Clear Coating Composition Containing Silicone Resin Emulsion

### Production Example 3-1-1

### Production of Silicone Resin Emulsion (S-1)

To a stainless steel container were added 25 parts by mass of LATEMUL PD-104 (produced by Kao Corporation, anionic emulsifier; content of components: 20% by mass) as emulsifier (C-1) and 152 parts by mass of ion-exchanged water, and then 200 parts by mass of SR-2400 (produced by Dow Corning Toray Silicone Co., Ltd., branched organopolysiloxane; weight average molecular weight: 20,000, viscosity: 15 mPa·s, solid concentration: 50% by mass, organic solvent (B-1): toluene) was added as silicone resin (A1-1) with stirring and was stirred for 15 minutes at 1,500 rpm using a disper (total quantity: 377 parts by mass, solid content: 105 parts by mass).

Subsequently, 0.057 parts by mass of SN-777 (produced by San Nopco Ltd., defoamer) was added and then was treated at 35 MPa using a high pressure homogenizer H20-H2 (manufactured by Sanwa Engineering Co., Ltd.), and thus 377 parts by mass of an emulsified mixture was obtained.

Furthermore, the emulsion was heated to 55° C. and desolventized under reduced pressure, so that the organic solvent (B-1) was distilled off together with water, and thus 247 parts by mass of silicone resin emulsion (S-1) (solid concentration: 42% by mass) was obtained.

The obtained silicone resin emulsion (S-1) had an average particle diameter of 345 nm.

### Production Example 3-1-2

### Production of Silicone Resin Emulsion (S-2)

In a stainless steel container were mixed 180 parts by mass of silicone resin (A1-1) and 10 parts by mass of XC96-723 (produced by Momentive Performance Materials Inc., linear organopolysiloxane; weight average molecular weight: 2,200, viscosity: 30 mPa·s, solid concentration: 100% by mass) as silicone resin (A2-1). The obtained mixture had a viscosity of 17 mPa·s.

To another container were added 25 parts by mass of anionic emulsifier (C-1) and 152 parts by mass of ion-exchanged water, 190 parts by mass of the above mixture was added with stirring, and the mixture was stirred at 1,500 rpm for 15 minutes using a disper (total quantity: 367 parts by mass, solid content: 105 parts by mass).

Subsequently, 0.057 parts by mass of SN-777 (produced by San Nopco Ltd., defoamer) was added and then was treated at 35 MPa using a high pressure homogenizer H20-H2 (manufactured by Sanwa Engineering Co., Ltd.), and thus 367 parts by mass of an emulsified mixture was obtained.

Furthermore, the emulsion was heated to 55° C. and desolventized under reduced pressure, so that the organic solvent (B-1) was distilled off together with water, and thus 247 parts by mass of silicone resin emulsion (S-2) (solid concentration: 42% by mass) was obtained.

The obtained silicone resin emulsion (S-2) had an average particle diameter of 350 nm.

### Production Example 3-1-3

### Production of Silicone Resin Emulsion (S-3)

In a stainless steel container were mixed 120 parts by mass of silicone resin (A1-1) and 40 parts by mass of silicone resin (A2-1). The obtained mixture had a viscosity of 22 mPa·s.

To another container were added 25 parts by mass of anionic emulsifier (C-1) and 152 parts by mass of ion-exchanged water, 160 parts by mass of the above mixture was added with stirring, and the mixture was stirred at 1,500 rpm for 15 minutes using a disper (total quantity: 337 parts by mass, solid content: 105 parts by mass).

Subsequently, 0.057 parts by mass of SN-777 (produced by San Nopco Ltd., defoamer) was added and then was treated at 35 MPa using a high pressure homogenizer H20-H2 (manufactured by Sanwa Engineering Co., Ltd.), and thus 337 parts by mass of an emulsified mixture was obtained.

Furthermore, the emulsion was heated to 55° C. and desolventized under reduced pressure, so that the organic solvent (B-1) was distilled off together with water, and thus 247 parts by mass of silicone resin emulsion (S-3) (solid concentration: 42% by mass) was obtained.

The obtained silicone resin emulsion (S-3) had an average particle diameter of 360 nm.

### Production Example 3-1-4

### Production of Silicone Resin Emulsion (S-4)

In a stainless steel container were mixed 80 parts by mass of silicone resin (A1-1) and 60 parts by mass of silicone resin (A2-1). The obtained mixture had a viscosity of 26 mPa·s.

To another container were added 25 parts by mass of anionic emulsifier (C-1) and 152 parts by mass of ion-exchanged water, 140 parts by mass of the above mixture was added with stirring, and the mixture was stirred at 1,500 rpm for 15 minutes using a disper (total quantity: 317 parts by mass, solid content: 105 parts by mass).

Subsequently, 0.057 parts by mass of SN-777 (produced by San Nopco Ltd., defoamer) was added and then was treated at 35 MPa using a high pressure homogenizer H20-H2 (manufactured by Sanwa Engineering Co., Ltd.), and thus 317 parts by mass of an emulsified mixture was obtained.

Furthermore, the emulsion was heated to 55° C. and desolventized under reduced pressure, so that the organic solvent (B-1) was distilled off together with water, and thus 247 parts by mass of silicone resin emulsion (S-4) (solid concentration: 42% by mass) was obtained.

The obtained silicone resin emulsion (S-4) had an average particle diameter of 350 nm.

### Production Example 3-1-5

### Production of Silicone Resin Emulsion (S-5)

In a stainless steel container were mixed 40 parts by mass of silicone resin (A1-1) and 80 parts by mass of silicone resin (A2-1). The obtained mixture had a viscosity of 28 mPa·s.

To another container were added 25 parts by mass of anionic emulsifier (C-1) and 152 parts by mass of ion-exchanged water, 120 parts by mass of the above mixture was added with stirring, and the mixture was stirred at 1,500 rpm for 15 minutes using a disper (total quantity: 297 parts by mass, solid content: 105 parts by mass).

Subsequently, 0.057 parts by mass of SN-777 (produced by San Nopco Ltd., defoamer) was added and then was treated at 35 MPa using a high pressure homogenizer H20-H2 (manufactured by Sanwa Engineering Co., Ltd.), and thus 297 parts by mass of an emulsified mixture was obtained.

Furthermore, the emulsion was heated to 55° C. and desolventized under reduced pressure, so that the organic solvent (B-1) was distilled off together with water, and thus 247 parts by mass of silicone resin emulsion (S-5) (solid concentration: 42% by mass) was obtained.

The obtained silicone resin emulsion (S-5) had an average particle diameter of 355 nm.

### Production Example 3-1-6

### Production of Silicone Resin Emulsion (5-6)

To a stainless steel container were added 25 parts by mass of anionic emulsifier (C-1) and 122 parts by mass of ion-exchanged water, 100 parts by mass of silicone resin (A2-1) was added with stirring, and the mixture was stirred at 1,500 rpm for 15 minutes using a disper (total quantity: 247 parts by mass, solid content: 105 parts by mass).

Subsequently, 0.057 parts by mass of SN-777 (produced by San Nopco Ltd., defoamer) was added and then was treated at 35 MPa using a high pressure homogenizer H20-H2 (manufactured by Sanwa Engineering Co., Ltd.), and thus 247 parts by mass (solid content: 42% by mass) of silicone resin emulsion (5-6) was obtained.

The obtained silicone resin emulsion (S-6) had an average particle diameter of 360 nm.

### Production Example 3-1-7

### Production of Silicone Resin Emulsion (S-7)

In a stainless steel container equipped with a desolventization device were mixed 140 parts by mass of silicone resin (A1-1), 30 parts by mass of silicone resin (A2-1) and 15 parts by mass of Cactus Solvent P-150 (produced by JXTG Nippon Oil & Energy Corporation) as organic solvent (B-3), and thus 185 parts by mass of a mixture was obtained. The obtained mixture was heated to 75° C. and desolventized under reduced pressure, so that 70 parts by mass of organic solvent (B-1) was distilled off. The mixture had a viscosity of 1,800 mPa·s.

To another stainless steel container were added 25 parts by mass of emulsifier (C-1) and 107 parts by mass of ion-exchanged water, 115 parts by mass of the above mixture was added with stirring, and the mixture was stirred at 1,500 rpm for 15 minutes using a disper (total quantity: 247 parts by mass, solid content: 105 parts by mass).

Subsequently, 0.057 parts by mass of SN-777 was added and then was treated at 35 MPa using a high pressure homogenizer H20-H2 (manufactured by Sanwa Engineering Co., Ltd.), and thus 247 parts by mass (solid concentration: 42% by mass) of silicone resin emulsion (S-7) was obtained.

The obtained silicone resin emulsion (S-7) had an average particle diameter of 1,800 nm. In addition, when the silicone resin emulsion (S-7) was allowed to stand for 1 day, separation and sedimentation occurred.

### Production Example 3-1-8

### Production of Silicone Resin Emulsion (S-8)

In a stainless steel container equipped with a desolventization device were mixed 140 parts by mass of silicone resin (A1-1), 30 parts by mass of silicone resin (A2-1) and 70 parts by mass of butoxypropanol as organic solvent (b-1), and thus 240 parts by mass of a mixture was obtained. The obtained mixture was heated to 75° C. and desolventized under reduced pressure, so that 70 parts by mass of organic solvent (B-1) was distilled off, and thus 170 parts by mass of a resin mixture containing only (b-1) as an organic solvent was obtained. The mixture had a viscosity of 20 mPa·s.

To another stainless steel container were added 25 parts by mass of emulsifier (C-1) and 152 parts by mass of ion-exchanged water, 170 parts by mass of the above mixture was added with stirring, and the mixture was stirred at 1,500 rpm for 15 minutes using a disper (total quantity: 347 parts by mass, solid content: 105 parts by mass).

Subsequently, 0.057 parts by mass of SN-777 was added and then was treated at 35 MPa using a high pressure homogenizer H20-H2 (manufactured by Sanwa Engineering Co., Ltd.), and thus 347 parts by mass (solid content: 105 parts by mass) of a silicone resin emulsion was obtained.

Furthermore, the emulsion was heated to 55° C. and desolventized under reduced pressure, so that 100 parts by mass in total of water and organic solvent (b-2) were distilled off, and thus 247 parts by mass of silicone resin emulsion (S-8) (solid concentration: 42% by mass) was obtained.

While the obtained silicone resin emulsion (S-8) had an average particle diameter of 320 nm, separation and sedimentation occurred when it was allowed to stand for 30 days.

### Production Example 3-1-9

### Production of Silicone Resin Emulsion (S-9)

To a stainless steel container equipped with a disper were added 25 parts by mass of emulsifier (C-1) and 93 parts by mass of ion-exchanged water, 170 parts by mass of a mixture of 140 parts by mass of silicone resin (A1-1) and 30 parts by mass of silicone resin (A2-1) prepared in advance was added with stirring at 1,500 rpm, and the resultant was stirred for 15 minutes (total quantity: 288 parts by mass, solid content; 105 parts by mass).

The obtained silicone resin emulsion (S-9) had an average particle diameter of 10,000 nm or more. In addition, when the silicone resin emulsion (S-9) was allowed to stand for 1 day, separation and sedimentation occurred.

Furthermore, the m/n value of the silicone resin (A1-1) was calculated from the weight average molecular weight measured by a gel permeation chromatograph HLC-8220GPC (manufactured by Tosoh Corporation) and the compositional ratio of R¹SiO_{3/2} and R²₂SiO determined from 29Si-NMR DPX400 (manufactured by Bruker), and it was found that m/n=180/60.

The viscosity of the mixture before mechanical emulsification treatment containing the silicone resin (A) and the organic solvent (B) was measured with a TVB-10 type viscometer (TVB-10H, manufactured by Toki Sangyo Co., Ltd.; measurement temperature: 25° C., rotation speed: 60 rpm).

The average particle diameter of the silicone resin emulsion was measured using an electrophoretic light scattering photometer ELSZ (manufactured by Otsuka Electronics Co., Ltd.) by diluting its aqueous dispersion with deionized water so that the signal level became appropriate.

The residual amount of toluene (B-1) contained in the silicone resin obtained in the above Production Example was measured using a gas chromatograph GC-2014 (manufactured by Shimadzu Corporation).

### Production Example 3-2-1

Production of Dispersion (d-11) of Inorganic Oxide Fine Particles (D-1)

100 parts by mass of FINEX-52W-LP2 (produced by Sakai Chemical Industry Co., Ltd.), which is surface-coated zinc oxide, 50 parts by mass of DISPERBYK2012 (produced by BYK Chemie, copolymer type polymer dispersant, non-volatiles content: 40%), 176 parts by mass of ion-exchanged water, and 14 parts by mass of Butyl Cellosolve were placed in a wet medium stirrer and were subjected to wet medium stirring for 30 minutes in the presence of zirconia medium particles (average particle diameter: 0.05 mm), and thus dispersion (d-11) of inorganic oxide fine particles (D-1) was obtained.

The dispersion (d-11) of the inorganic oxide fine particles (D-1) had an average particle diameter (50% volume particle diameter D₅₀) of 290 nm.

### Production Examples 3-2-2 to 3-2-4

Production of Dispersions (d-12) to (d-14) of Inorganic Oxide Fine Particles (D-1)

Dispersions (d-12) to (d-14) of the inorganic oxide fine particles (D-1) were obtained in the same manner as in Production Example 2-1 except that the wet medium stirring time was changed as shown in the following table.

### Production Example 3-2-5

Production of Dispersion (d-21) of Inorganic Oxide Fine Particles (D-2)

Dispersion (d-21) of inorganic oxide fine particles (D-2) was obtained in the same manner as in Production Example 3-2-2 except that the surface-coated zinc oxide was altered by STR-100A-LP (produced by Sakai Chemical Industry Co., Ltd.), which is titanium oxide.

The dispersion (d-21) of the inorganic oxide fine particles (D-2) had an average particle diameter (D ₅₀) of 110 nm.

TABLE 6

| | Dispersion of Inorganic oxide fine particle | | | | |
|---|---|---|---|---|---|
| | (d-11) | (d-12) | (d-13) | (d-14) | (d-21) |
| Inorganic oxide fine | ZnO | ZnO | ZnO | ZnO | TiO₂ |
| particle (D) | (D-1) | (D-1) | (D-1) | (D-1) | (D-2) |
| Time of wet medium | 30 | 60 | 120 | 5 | 60 |
| stirring (minutes) | | | | | |
| Average particle | 290 | 120 | 70 | 600 | 110 |
| diameter D50 (nm) | | | | | |

The average particle diameter of the inorganic oxide fine particles (D) is 50% volume particle diameter (D₅₀). The average particle diameter (D₅₀) was measured using UPA-150 (particle size distribution analyzer manufactured by MicrotracBEL Corp.).

### Example 3-1

### Preparation of Aqueous Clear Coating Composition

To 100 parts by mass of the silicone resin emulsion (S-2) obtained in Production Example (3-1-2) was added 0.15 parts by mass of ammonia water, and then 2 parts by mass of Primal ASE-60 (produced by The Dow Chemical Company) as an alkali swelling type thickener was added and mixed. Subsequently, 14.6 parts by mass of the dispersion (d-11) of the inorganic oxide fine particles (D-1) and 78.6 parts by mass of tap water were mixed, and 1.23 parts by mass of DIBUTYL TIN OXIDE (produced by Nitto Kasei Co., Ltd.) as a curing catalyst was added and mixed, and thus an aqueous clear coating composition was obtained.

### Examples 3-2 to 3-16, Comparative Examples 3-1, 3-3 to 3-5

Aqueous clear coating compositions were obtained in the same manner as in Example 1 except that the types and the amounts of the silicone resin emulsion and the inorganic oxide fine particle dispersion were changed as shown in the following tables.

### Example 3-17

90 parts by mass of the silicone resin emulsion (S-1) and 10 parts by mass of the silicone resin emulsion (S-6) obtained in Production Examples were mixed, and 0.15 parts by mass of ammonia water was added to and mixed. Next, 2 parts by mass of Primal ASE60 was added and mixed. Subsequently, 14.6 parts by mass of the dispersion (d-11) of the inorganic oxide fine particles (D-1) and 78.6 parts by mass of tap water were mixed, and 1.23 parts by mass of DIBUTYL TIN OXIDE as a curing catalyst was added and mixed, and thus an aqueous clear coating composition was obtained.

### Comparative Example 3-2

### Acrylic Resin Emulsion

0.15 parts by mass of 25% ammonia water was mixed with 100 parts by mass of ACRYSET EX-41 (produced by Nippon Shokubai Co., Ltd., solid concentration: 43% by mass) as an acrylic resin emulsion, and to the mixture was added and mixed 2 parts by mass of Primal ASE-60. Subsequently, 14.6 parts by mass of the dispersion (d-11) of the inorganic oxide fine particles (D-1) and 78.6 parts by mass of tap water were mixed, and 1 part by mass of CS-12 (produced by Chisso Corporation) as a film-forming aid was added and mixed, and thus an aqueous clear coating composition was obtained.

### Comparative Example 3-6

An aqueous clear coating composition was obtained in the same manner as in Example 3-3-1 except that the dispersion (d-11) of the inorganic oxide fine particles (D-1) was not used.

The organic solvents (B) and the emulsifiers (C) used in the respective Examples and Comparative Examples are as follows. Organic solvent (B-1): toluene (azeotropic point with water: 85° C., solubility in water: 0.047 g/100 g-H₂O)
Organic solvent (B-3): Cactus Solvent P-150 (produced by JXTG Nippon Oil & Energy Corporation, azeotropic point with water: no, solubility in water: 0.04 g/100 g-H₂O)
Organic solvent (b-1): butoxypropanol (azeotropic point with water: no, solubility in water: 5.5 g/100 g-H₂O)
Emulsifier (C-1): LATEMUL PD-104 (produced by Kao Corporation, anionic, content of components: 20% by mass)

The following evaluations were carried out using the aqueous clear coating compositions obtained in the above Examples and Comparative Examples. The results of the evaluations are shown in the following tables.

### Paint Stability Evaluation

Each of the silicone resin emulsions obtained in the above Examples and Comparative Examples was filtered through a 200 mesh filter and then was allowed to stand at 40° C. for 3 months. The state of the silicone resin emulsion after standing was visually observed and the paint stability was evaluated according to the following criteria.
◯: No separation/sedimentation, etc. occurred.
×: Separation/sedimentation occurred.

### Coating Film Appearance (Initial Appearance of Coating Film After Coating)

Each of the aqueous clear coating compositions obtained in Examples and Comparative Examples was applied to a quartz glass plate (a substrate having no absorption in the ultraviolet range) by using a doctor blade (2 mil) to have a dried film thickness of 10 μm and then was dried at 160° C. for 10 minutes, and thus an evaluation test plate was obtained.

The coating film appearance of the obtained evaluation test plate was visually evaluated according to the following criteria.
◯: The coating film is transparent and no aggregate is observed.
Δ: Slight cloudiness caused by inorganic oxide fine particles and/or slight aggregation of inorganic oxide fine particles are observed in the coating film.
×: Entirely spread cloudiness caused by inorganic oxide fine particles and/or many aggregates of inorganic oxide fine particles are observed in the coating film.

### Measurement of Ultraviolet Transmittance and Visible Light Transmittance (Before Accelerated Weatherability Test)

Each of the aqueous clear coating compositions obtained in Examples and Comparative Examples was applied to a quartz glass plate (a substrate having no absorption in the ultraviolet range) by using a doctor blade (2 mil) to have a dried film thickness of 10 μm and then was dried at 160° C. for 10 minutes, and thus an evaluation test plate was obtained.

The light transmittance at the wavelength of 280 nm to 780 nm of the evaluation test plate obtained above was measured using an ultraviolet visible spectrophotometer (UV-3100, manufactured by Shimadzu Corporation).

The light transmittance (%) in the wavelength range of 280 to 380 nm was determined as an ultraviolet transmittance (%). Specifically, a transmission spectrum from 280 nm to 380 nm in wavelength was measured, and an ultraviolet transmittance was obtained from the integrated value. More specifically, light transmittance in the wavelength range of 280 to 380 nm was measured at 51 points every 2 nm, and the average value thereof was taken as an ultraviolet transmittance.

As a visible transmittance (%), the average value of light transmittance (%) in the wavelength range of 380 to 780 nm was determined. Specifically, the transmission spectrum was measured every 2 nm in the wavelength range from 380 nm to 780 nm, and a visible light transmittance was obtained from the integrated value.

### Weatherability Evaluation (Ultraviolet Light Transmittance After Accelerated Weatherability Test)

An accelerated weatherability test was carried out for the above-obtained evaluation test plate using sunshine weatherometer (manufactured by Suga Test Instruments Co., Ltd.) (operating conditions: according to JIS K 5400, operation time: 10,000 hours).

The ultraviolet transmittance (%) of the evaluation test plate after the accelerated weatherability test was measured by the same method as above.

### Evaluation of Weatherability (Evaluation of Coating Film Appearance After Accelerated Weatherability Test)

An accelerated weatherability test was carried out for the above-obtained evaluation test plate using sunshine weatherometer (manufactured by Suga Test Instruments Co., Ltd.) (operating conditions: according to JIS K 5400, operation time: 10,000 hours).

The appearance of the coating film of the evaluation test plate after accelerated weatherability test was visually evaluated according to the following criteria.
◯: There is no change.
◯Δ: Slight whitening is observed in the coating film.
Δ: Whitening is observed in a part of the coating film.
Δ×: Whitening and/or cracking was observed in the coating film.
×: Remarkable whitening and/or delamination was observed in the coating film.

TABLE 7

| | | | | | Exam. | Exam. | Exam. | Exam. | Exam. | Exam. | Exam. |
|---|---|---|---|---|---|---|---|---|---|---|---|
| | | | | | 3-1 | 3-2 | 3-3 | 3-4 | 3-5 | 3-6 | 3-7 |
| | Silicone resin emulsion (S) | | | | (S-2) | (S-2) | (S-2) | (S-2) | (S-2) | (S-2) | (S-2) |
| | Silicone resin | Type | Mw | | | | | | | | |
| Com- | Branched | (A1-1) | 20,000 | | 90 | 90 | 90 | 90 | 90 | 90 | 90 |
| position | organopoly- | | | | | | | | | | |
| | siloxane (A1) | | | | | | | | | | |
| | Liner | (A2-1) | 2,200 | | 10 | 10 | 10 | 10 | 10 | 10 | 10 |
| | organopoly- | | | | | | | | | | |
| | siloxane (A2) | | | | | | | | | | |
| | Acrylic resin emulsion | | | | | | | | | | |
| | | | | Solubility in water | | | | | | | |
| | | Type | Name | (g/100 gH₂O) | | | | | | | |
| | Organic | (B-1) | Toluene | 0.047 | 90 | 90 | 90 | 90 | 90 | 90 | 90 |
| | solvent (B) | (B-3) | Cactus Solvent | 0.04 | | | | | | | |
| | | | P-150 | | | | | | | | |
| | | (b-1) | Butoxy- | 5.5 | | | | | | | |
| | | | propanol | | | | | | | | |
| | | | Inorganic oxide | | | | | | | | |
| | | Type | fine particle | | | | | | | | |
| | Dispersion of | (d-11) | Zinc oxide | | 14.6 | | | 7.3 | | | 29.2 |
| | inorganic | (d-12) | Zinc oxide | | | 14.6 | | | 7.3 | | |
| | oxide fine | (d-13) | Zinc oxide | | | | 14.6 | | | 7.3 | |
| | particle (D) | (d-14) | Zinc oxide | | | | | | | | |
| | | (d-21) | Titanium oxide | | | | | | | | |

| | Organic ultraviolet absorber | | | | | | | | | |
|---|---|---|---|---|---|---|---|---|---|---|
| Mass ratio of (A1), (A2) ((A1):(A2)) | | | | 9:1 | 9:1 | 9:1 | 9:1 | 9:1 | 9:1 | 9:1 |
| Amount of the inorganic oxide fine particle (D) or an organic ultraviolet | | | | 10.7 | 10.7 | 10.7 | 5.4 | 5.4 | 5.4 | 21.5 |
| absorber based on 100 parts by mass of the total resin solid content of (A1) | | | | | | | | | | |
| and (A2) (parts by mass) | | | | | | | | | | |
| Step | Desolventization | Distill of solvent before | Amounts of distilled | — | — | — | — | — | — | — |
| | step | emulsification | organic solvent | | | | | | | |
| | | | (Desolvation amount (g)) | | | | | | | |
| | Before | Mass ratio (A):(B) before mechanical emulsification | | 1:0.9 | 1:0.9 | 1:0.9 | 1:0.9 | 1:0.9 | 1:0.9 | 1:0.9 |
| | emulsification | treatment | | | | | | | | |
| | step | Viscosity of mixture containing (A) + (B) before | | 17 | 17 | 17 | 17 | 17 | 17 | 17 |
| | | mechanical emulsification treatment (mPa · s) | | | | | | | | |
| | emulsification | Presence (P) or absence (A) of mechanincal | | P | P | P | P | P | P | P |
| | step | treatment | | | | | | | | |
| | | Mass ratio (A):(B) in emulsified mixture | | 1:0.9 | 1:0.9 | 1:0.9 | 1:0.9 | 1:0.9 | 1:0.9 | 1:0.9 |
| | Desolventization | Distill of solvent after | Amounts of distilled | 120 | 120 | 120 | 120 | 120 | 120 | 120 |
| | step | emulsification | organic solvent | | | | | | | |
| | | | (Desolvation amount (g)) | | | | | | | |

| | | | | | | | | |
|---|---|---|---|---|---|---|---|---|
| Evaluation | Average particle diameter of of silicone resin emulsion for preparing a | 350 | 350 | 350 | 350 | 350 | 350 | 350 |
| | coating composition (nm) | | | | | | | |
| | Residual amount of organic solvent (%) | <0.1 | <0.1 | <0.1 | <0.1 | <0.1 | <0.1 | <0.1 |
| | Paint stability | ∘ | ∘ | ∘ | ∘ | ∘ | ∘ | ∘ |
| | Visible light transmittance (%) before accelerated weatherability test | 80 | 83 | 87 | 85 | 88 | 91 | 71 |
| | Ultraviolet transmittance (%) before accelerated weatherabilty test | 15 | 13 | 10 | 19 | 17 | 16 | 8 |
| | Initial appearance of coating film after coating | ∘ | ∘ | ∘ | ∘ | ∘ | ∘ | ∘ |
| | Weatherability evaluation (Ultraviolet light transmittance (%) after | 17 | 15 | 11 | 20 | 19 | 18 | 10 |
| | accelerated weatherability test) | | | | | | | |
| | Evaluation of weatherabilty (Evaluation of coating film appearance | ∘ | ∘ | ∘ | ∘ | ∘ | ∘ | ∘ |
| | after accelerated weatherability test) | | | | | | | |

| | | | | | Exam. | Exam. | Exam. | Exam. | Exam. | Exam. |
|---|---|---|---|---|---|---|---|---|---|---|
| | | | | | 3-8 | 3-9 | 3-10 | 3-11 | 3-12 | 3-13 |
| | Silicone resin emulsion (S) | | | | (S-2) | (S-2) | (S-2) | (S-2) | (S-1) | (S-3) |
| | Silicone resin | Type | Mw | | | | | | | |
| Composition | Branched | (A1-1) | 20,000 | | 90 | 90 | 90 | 90 | 100 | 60 |
| | organopoly- | | | | | | | | | |
| | siloxane (A1) | | | | | | | | | |
| | Liner | (A2-1) | 2,200 | | 10 | 10 | 10 | 10 | | 40 |
| | organopoly- | | | | | | | | | |
| | siloxane (A2) | | | | | | | | | |
| | Acrylic resin emulsion | | | | | | | | | |
| | | | | Solubility in water | | | | | | |
| | | Type | Name | (g/100 gH₂O) | | | | | | |
| | Organic | (B-1) | Toluene | 0.047 | 90 | 90 | 90 | 90 | 100 | 60 |
| | solvent (B) | (B-3) | Cactus Solvent | 0.04 | | | | | | |
| | | | P-150 | | | | | | | |
| | | (b-1) | Butoxy- | 5.5 | | | | | | |
| | | | propanol | | | | | | | |
| | | | Inorganic oxide | | | | | | | |
| | | Type | fine particle | | | | | | | |
| | Dispersion of | (d-11) | Zinc oxide | | | | 2.4 | 58.4 | 14.6 | 14.6 |
| | inorganic | (d-12) | Zinc oxide | | 29.2 | | | | | |
| | oxide fine | (d-13) | Zinc oxide | | | 29.2 | | | | |
| | particle (D) | (d-14) | Zinc oxide | | | | | | | |
| | | (d-21) | Titanium oxide | | | | | | | |

| | Organic ultraviolet absorber | | | | | | | | |
|---|---|---|---|---|---|---|---|---|---|
| Mass ratio of (A1), (A2) ((A1):(A2)) | | | | 9:1 | 9:1 | 9:1 | 9:1 | 10:0 | 6:4 |
| Amount of the inorganic oxide fine particle (D) or an organic ultraviolet | | | | 21.5 | 21.5 | 1.8 | 42.9 | 10.7 | 10.7 |
| absorber based on 100 parts by mass of the total resin solid content of (A1) | | | | | | | | | |
| and (A2) (parts by mass) | | | | | | | | | |
| Step | Desolventization | Distill of solvent before | Amounts of distilled | — | — | — | — | — | — |
| | step | emulsification | organic solvent | | | | | | |
| | | | (Desolvation amount (g)) | | | | | | |

| Before | Mass ratio (A):(B) before mechanical emulsification | | 1:0.9 | 1:0.9 | 1:0.9 | 1:0.9 | 1:1 | 1:0.6 |
|---|---|---|---|---|---|---|---|---|
| emulsification | treatment | | | | | | | |
| step | Viscosity of mixture containing (A) + (B) before | | 17 | 17 | 17 | 17 | 15 | 22 |
| | mechanical emulsification treatment (mPa · s) | | | | | | | |
| emulsification | Presence (P) or absence (A) of mechanincal | | P | P | P | P | P | P |
| step | treatment | | | | | | | |
| | Mass ratio (A):(B) in emulsified mixture | | 1:0.9 | 1:0.9 | 1:0.9 | 1:0.9 | 1:1 | 1:0.6 |
| Desolventization | Distill of solvent after | Amounts of distilled | 120 | 120 | 120 | 130 | 90 | 70 |
| step | emulsification | organic solvent | | | | | | |
| | | (Desolvation amount (g)) | | | | | | |

| | | | | | | | |
|---|---|---|---|---|---|---|---|
| Evaluation | Average particle diameter of of silicone resin emulsion for preparing a | 350 | 350 | 350 | 350 | 345 | 360 |
| | coating composition (nm) | | | | | | |
| | Residual amount of organic solvent (%) | <0.1 | <0.1 | <0.1 | <0.1 | <0.1 | <0.1 |
| | Paint stability | ∘ | ∘ | ∘ | ∘ | ∘ | ∘ |
| | Visible light transmittance (%) before accelerated weatherability test | 74 | 77 | 90 | 59 | 80 | 79 |
| | Ultraviolet transmittance (%) before accelerated weatherabilty test | 5 | 3 | 30 | 2 | 16 | 15 |
| | Initial appearance of coating film after coating | ∘ | ∘ | ∘ | Δ | ∘ | ∘ |
| | Weatherability evaluation (Ultraviolet light transmittance (%) after | 6 | 5 | 30 | 3 | 16 | 17 |
| | accelerated weatherability test) | | | | | | |
| | Evaluation of weatherabilty (Evaluation of coating film appearance | ∘ | ∘ | ∘Δ | ∘Δ | ∘Δ | ∘ |
| | after accelerated weatherability test) | | | | | | |

TABLE 8

| | | | | | Exam. | Exam. | Exam. | Exam. | Com. |
|---|---|---|---|---|---|---|---|---|---|
| | | | | | 3-14 | 3-15 | 3-16 | 3-17 | Ex. 3-1 |
| | Silicone resin emulsion (S) | | | | (S-4) | (S-5) | (S-2) | (S-1) (S-6) | (S-6) |
| | Silicone resin | Type | Mw | | | | | | |
| Composition | Branched | (A1-1) | 20,000 | | 40 | 20 | 90 | 90 | |
| | organopoly- | | | | | | | | |
| | siloxane (A1) | | | | | | | | |
| | Liner | (A2-1) | 2,200 | | 60 | 80 | 10 | 10 | 100 |
| | organopoly- | | | | | | | | |
| | siloxane (A2) | | | | | | | | |
| | Acrylic resin emulsion | | | | | | | | |
| | | | | Solubility in water | | | | | |
| | | Type | Name | (g/100 gH₂O) | | | | | |
| | Organic | (B-1) | Toluene | 0.047 | 40 | 20 | 90 | 90 | 0 |
| | solvent (B) | (B-3) | Cactus Solvent | 0.04 | | | | | |
| | | | P-150 | | | | | | |
| | | (b-1) | Butoxy- | 5.5 | | | | | |
| | | | propanol | | | | | | |
| | | | Inorganic oxide | | | | | | |
| | | Type | fine particle | | | | | | |
| | Dispersion of | (d-11) | Zinc oxide | | 14.6 | 14.6 | | 14.6 | 14.6 |
| | inorganic | (d-12) | Zinc oxide | | | | | | |
| | oxide fine | (d-13) | Zinc oxide | | | | | | |
| | particle (D) | (d-14) | Zinc oxide | | | | | | |
| | | (d-21) | Titanium oxide | | | | 14.6 | | |
| | Organic ultraviolet absorber | | | | | | | | |
| Mass ratio of (A1), (A2) ((A1:A2)) | | | | | 4:6 | 2:8 | 9:1 | 9:1 | 0:10 |
| Amount of the inorganic oxide fine particle (D) or an organic ultraviolet | | | | | 10.7 | 10.7 | 10.7 | 10.7 | 10.7 |
| absorber based on 100 parts by mass of the total resin solid content of (A1) | | | | | | | | | |
| and (A2) (parts by mass) | | | | | | | | | |
| Step | Desolventization | Distill of solvent before | | Amounts of distilled | — | — | — | — | — |
| | step | emulsification | | organic solvent | | | | | |
| | | | | (Desolvation amount (g)) | | | | | |
| | Before | Mass ratio (A):(B) before mechanical emulsification | | | 1:0.4 | 1:0.2 | 1:0.9 | 1:1 | 1:0 |
| | emulsification | treatment | | | | | | | |
| | step | Viscosity of mixture containing (A) + (B) before | | | 26 | 28 | 17 | 15 | 30 |
| | | mechanical emulsification treatment (mPa · s) | | | | | | | |
| | emulsification | Presence (P) or absence (A) of mechanincal | | | P | P | P | P | P |
| | step | treatment | | | | | | | |
| | | Mass ratio (A):(B) in emulsified mixture | | | 1:0.4 | 1:0.2 | 1:0.9 | 1:1 | 1:0 |
| | Desolventization | Distill of solvent after | | Amounts of distilled | 50 | 120 | 130 | 120 | — |
| | step | emulsification | | organic solvent | | | | | |
| | | | | (Desolvation amount (g)) | | | | | |
| Evaluation | Average particle diameter of of silicone resin emulsion for preparing a | | | | 350 | 355 | 350 | 345/360 | 360 |
| | coating composition (nm) | | | | | | | | |
| | Residual amount of organic solvent (%) | | | | <0.1 | <0.1 | <0.1 | <0.1 | 0 |
| | Paint stability | | | | ∘ | ∘ | ∘ | ∘ | ∘ |
| | Visible light transmittance (%) before accelerated weatherability test | | | | 80 | 80 | 75 | 80 | 82 |
| | Ultraviolet transmittance (%) before accelerated weatherability test | | | | 16 | 15 | 13 | 13 | 15 |
| | Initial appearance of coating film after coating | | | | ∘ | ∘ | ∘ | ∘ | ∘ |
| | Weatherability evaluation (Ultraviolet light transmittance (%) after | | | | 17 | 17 | 13 | 14 | 35 |
| | accelerated weatherability test) | | | | | | | | |
| | Evaluation of weatherability (Evaluation of coating film appearance | | | | ∘Δ | Δ | ∘ | ∘ | x |
| | after accelerated weatherability test) | | | | | | | | |
| | | | | | Com. | Com. | Com. | Com. | Com. |
| | | | | | Ex. 3-2 | Ex. 3-3 | Ex. 3-4 | Ex. 3-5 | Ex. 3-6 |
| | Silicone resin emulsion (S) | | | | — | (S-7) | (S-8) | (S-9) | (S-2) |
| | Silicone resin | Type | Mw | | | | | | |
| Composition | Branched | (A1-1) | 20,000 | | | 70 | 70 | 70 | 90 |
| | organopoly- | | | | | | | | |
| | siloxane (A1) | | | | | | | | |
| | Liner | (A2-1) | 2,200 | | | 30 | 30 | 30 | 10 |
| | organopoly- | | | | | | | | |
| | siloxane (A2) | | | | | | | | |
| | Acrylic resin emulsion | | | | 100 | | | | |
| | | | | Solubility in water | | | | | |
| | | Type | Name | (g/100 gH₂O) | | | | | |
| | Organic | (B-1) | Toluene | 0.047 | — | 70 | 70 | 70 | 90 |
| | solvent (B) | (B-3) | Cactus Solvent | 0.04 | | 15 | | | |
| | | | P-150 | | | | | | |
| | | (b-1) | Butoxy- | 5.5 | | | 70 | | |
| | | | propanol | | | | | | |
| | | | Inorganic oxide | | | | | | |
| | | Type | fine particle | | | | | | |
| | Dispersion of | (d-11) | Zinc oxide | | 14.6 | 14.6 | 14.6 | 14.6 | |
| | inorganic | (d-12) | Zinc oxide | | | | | | |
| | oxide fine | (d-13) | Zinc oxide | | | | | | |
| | particle (D) | (d-14) | Zinc oxide | | | | | | |
| | | (d-21) | Titanium oxide | | | | | | |

| | Organic ultraviolet absorber | | | | | | | |
|---|---|---|---|---|---|---|---|---|
| Mass ratio of (A1), (A2) ((A1:A2)) | | | | — | 7:3 | 7:3 | 7:3 | 9:1 |
| Amount of the inorganic oxide fine particle (D) or an organic ultraviolet | | | | 10.7 | 10.7 | 10.7 | 10.7 | 0.0 |
| absorber based on 100 parts by mass of the total resin solid content of (A1) | | | | | | | | |
| and (A2) (parts by mass) | | | | | | | | |
| Step | Desolventization | Distill of solvent before | Amounts of distilled | — | 70 | 70 | — | — |
| | step | emulsification | organic solvent | | | | | |
| | | | (Desolvation amount (g)) | | | | | |
| | Before | Mass ratio (A):(B) before mechanical emulsification | | — | 1:0.15 | 1:0 | 1:0.7 | 1:0.9 |
| | emulsification | treatment | | | | | | |
| | step | Viscosity of mixture containing (A) + (B) before | | — | 1,800 | 20 | 20 | 17 |
| | | mechanical emulsification treatment (mPa · s) | | | | | | |
| | emulsification | Presence (P) or absence (A) of mechanincal | | A | P | P | A | P |
| | step | treatment | | | | | | |
| | | Mass ratio (A):(B) in emulsified mixture | | — | 1:0.15 | 1:0 | 1:0.7 | 1:0.9 |
| | Desolventization | Distill of solvent after | Amounts of distilled | — | 100 | — | 120 | ∘ |
| | step | emulsification | organic solvent | | | | | |
| | | | (Desolvation amount (g)) | | | | | |

| | | | | | | |
|---|---|---|---|---|---|---|
| Evaluation | Average particle diameter of of silicone resin emulsion for preparing a | 95 | 1,800 | 320 | >10,000 | 350 |
| | coating composition (nm) | | | | | |
| | Residual amount of organic solvent (%) | — | <0.1 | <0.1 | 24.3 | <0.1 |
| | Paint stability | ∘ | x | x | x | ∘ |
| | Visible light transmittance (%) before accelerated weatherability test | 83 | — | — | — | 98 |
| | Ultraviolet transmittance (%) before accelerated weatherability test | 15 | — | — | — | 87 |
| | Initial appearance of coating film after coating | ∘ | — | — | — | ∘ |
| | Weatherability evaluation (Ultraviolet light transmittance (%) after | 20 | — | — | — | 87 |
| | accelerated weatherability test) | | | | | |
| | Evaluation of weatherability (Evaluation of coating film appearance | Δx | — | — | — | x |
| | after accelerated weatherability test) | | | | | |

All of the aqueous clear coating compositions prepared in Examples were superior in paint stability, and the coating films obtained were confirmed to be high in visible transmittance and low in ultraviolet transmittance, and furthermore, sufficiently low in ultraviolet transmittance after the accelerated weatherability test. Furthermore, good coating film appearance was confirmed to be maintained even after the accelerated weatherability test.

Comparative Example 3-1 is an example in which the silicone resin (A) contains no branched organopolysiloxane (A1). In this example, the appearance of the coating film after the accelerated weatherability was confirmed to be poor.

Comparative Example 3-2 is an example in which an acrylic resin emulsion was used instead of a silicone resin emulsion. In this example, the appearance of the coating film after the accelerated weatherability was confirmed to be poor.

Comparative Example 3-3 is an example in which the organic solvent was removed before the emulsification step in the preparation of the silicone resin emulsion. In this example, it was confirmed that the stability of the obtained silicone resin emulsion was poor and the paint stability was also poor.

Comparative Example 3-4 is an example in which the organic solvent contained in the preparation of the silicone resin emulsion is a solvent other than the organic solvent (B). In this example, it was confirmed that the stability of the obtained silicone resin emulsion was poor and the paint stability was also poor.

Comparative Example 3-5 is an example in which no mechanical emulsification treatment was performed in the preparation of the silicone resin emulsion. In this example, it was confirmed that the obtained silicone resin emulsion was extremely large in average particle diameter and was inferior in stability and the paint stability was also poor.

Comparative Example 3-6 is an example in which no inorganic oxide fine particles (D) are contained and no organic ultraviolet absorber is contained. In this example, it was confirmed that the ultraviolet transmittance before the accelerated weatherability test and the ultraviolet transmittance after the accelerated weatherability test were high, the appearance of the coating film after the accelerated weatherability test deteriorated, and the performance as a clear coating composition was poor.

According to the production method of the present invention, it is possible to produce a silicone resin emulsion containing a branched organopolysiloxane (A1) which is a fine particle and is superior in storage stability. By the production method of the present invention, an aqueous silicone resin emulsion for preparing a coating composition can be produced.

In addition, according to the production method of the present invention, an aqueous coating composition containing a silicone resin emulsion containing a branched organopolysiloxane (A1) and a linear organopolysiloxane (A2) can be produced. The aqueous coating composition is advantageous in that it can form a coating film superior in weatherability and durability.

Furthermore, according to the production method of the present invention, it is possible to produce a silicone resin emulsion containing a branched organopolysiloxane (A1) which is fine particles and is superior in storage stability. By the production method of the present invention, an aqueous clear coating composition containing a silicone resin emulsion and an inorganic oxide fine particle can be produced. The above-mentioned aqueous clear coating composition is advantageous in that it can maintain an ultraviolet ray blocking property and visible light transparency for a long period of time. Furthermore, it is advantageous in that it becomes possible to prepare an aqueous clear coating composition without using any organic ultraviolet absorber.

What is claimed is:

1. A method for producing an aqueous silicone resin emulsion for preparing a coating composition, comprising the following steps:
an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture, and
a desolventization step of at least partially removing the organic solvent (B) from the resulting emulsified mixture, thereby obtaining an aqueous silicone resin emulsion for preparing a coating composition, wherein the silicone resin (A) comprises a branched organopolysiloxane (A1) having a weight average molecular weight within a range of 5,000 to 300,000,
the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water,
a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and a mass ratio (A):(B) of the silicone resin (A) and the organic solvent (B) contained in the emulsified mixture satisfies the relationship of (A):(B)=1:2 to 1:0.2.

2. The method according to claim 1, wherein the organic solvent (B) comprises at least one solvent selected from the group consisting of benzene, toluene, xylene, hexane and cyclohexane.

3. The method according to claim 1, wherein the emulsifier (C) comprises an anionic surfactant.

4. The method according to claim 1, wherein the mechanical emulsification treatment in the emulsification step is one or more selected from the group consisting of pressurized shear agitation treatment, counter impinging treatment, impinging agitation treatment and high speed rotary agitation treatment.

5. The method according to claim 1, wherein the aqueous silicone resin emulsion for preparing a coating composition has an average particle diameter within the range of 100 to 500 nm.

6. The method according to claim 1, wherein the branched organopolysiloxane (A1) is a branched organopolysiloxane (A1) having the following structure:
[R¹SiO_{3/2}]ₘ[R²₂SiO]ₙ
wherein R¹ and R² are each independently a hydroxyl group, a linear hydrocarbon group having 1 to 6 carbon atoms, or an aromatic hydrocarbon group having 5 to 7 carbon atoms,
m is 1 to 1,000, n is 1 to 100, and m+n is within a range of 1 to 1,000.

7. The method according to claim 1, wherein in the mixture before the mechanical emulsification treatment containing the silicone resin (A) and the organic solvent (B), a viscosity of the mixture of the silicone resin (A) and the organic solvent (B) is within a range of 10 to 1,500 mPa·s.

8. A method for preparing an aqueous coating composition comprising a silicone resin emulsion, comprising the following steps:
an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,
a desolventization step of at least partially removing the organic solvent (B) from the resulting emulsified mixture, thereby obtaining a silicone resin emulsion, and
a step of preparing an aqueous coating composition comprising the resulting silicone resin emulsion,
wherein the silicone resin (A) comprises
a branched organopolysiloxane (A1) having a weight average molecular weight within a range of 5,000 to 100,000, and
a linear organopolysiloxane (A2) having a weight average molecular weight within a range of 1,000 to 30,000,
a mass ratio of the branched organopolysiloxane (A1) and the linear organopolysiloxane (A2) contained in the aqueous coating composition is within a range of (A1):(A2)=98:2 to 40:60,
the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water, and
a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and amass ratio (A):(B) of the silicone resin (A) and the organic solvent (B) contained in the emulsified mixture satisfies the relationship of (A):(B)=1:2 to 1:0.2.

9. A method for preparing an aqueous coating composition comprising a silicone resin emulsion, comprising the following steps:
an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,
a desolventization step of at least partially removing the organic solvent (B) from the resulting emulsified mixture, thereby obtaining a silicone resin emulsion, and
a step of mixing the resulting silicone resin emulsion and an emulsion prepared in advance and comprising a linear organopolysiloxane (A2) having a weight average molecular weight within a range of 1,000 to 30,000, thereby preparing an aqueous coating composition,
wherein the silicone resin (A) comprises a branched organopolysiloxane (A1) having a weight average molecular weight within a range of 5,000 to 100,000, and
a mass ratio of the branched organopolysiloxane (A1) and the linear organopolysiloxane (A2) contained in the aqueous coating composition is within a range of (A1):(A2)=98:2 to 40:60,
the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water,
a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and a mass ratio (A):(B) of the silicone resin (A) and the organic solvent (B) contained in the emulsified mixture satisfies the relationship of (A):(B)=1:2 to 1:0.2.

10. The method according to claim 8, wherein the organic solvent (B) comprises at least one solvent selected from the group consisting of benzene, toluene, xylene, hexane and cyclohexane.

11. The method according to claim 8, wherein the emulsifier (C) comprises an anionic surfactant.

12. The method according to claim 8, wherein the mechanical emulsification treatment in the emulsification step is one or more selected from the group consisting of pressurized shear agitation treatment, counter impinging treatment, impinging agitation treatment and high speed rotary agitation treatment.

13. The method according to claim 8, wherein the aqueous silicone resin emulsion for preparing a coating composition has an average particle diameter within the range of 100 to 500 nm.

14. The method according to claim 8, wherein:
the branched organopolysiloxane (A1) is a branched organopolysiloxane (A1) having the following structure:
[R¹SiO_{3/2}]ₘ[R²₂SiO]ₙ
wherein R¹ and R² are each independently a hydroxyl group, a linear hydrocarbon group having 1 to 6 carbon atoms, or an aromatic hydrocarbon group having 5 to 7 carbon atoms,
m is 1 to 1,000, n is 1 to 100, and m+n is within a range of 1 to 1,000, and
the linear organopolysiloxane (A2) is a linear organopolysiloxane (A2) having the following structure:
R³—[R⁴₂SiO]ₓ—R⁵
wherein R³ is a hydroxyl group, a linear hydrocarbon group having 1 to 6 carbon atoms, or an aromatic hydrocarbon group having 5 to 7 carbon atoms,
R⁴ is a linear hydrocarbon group having 1 to 6 carbon atoms or an aromatic hydrocarbon group having 5 to 7 carbon atoms,
R⁵ is hydrogen, a linear hydrocarbon group having 1 to 6 carbon atoms, or an aromatic hydrocarbon group having 5 to 7 carbon atoms, and
x is within a range of 1 to 400.

15. The method according to claim 8, wherein in the mixture before the mechanical emulsification treatment containing the silicone resin (A) and the organic solvent (B), a viscosity of the mixture of the silicone resin (A) and the organic solvent (B) is within a range of 10 to 1,500 mPa·s.

16. The method according to claim 9, wherein the organic solvent (B) comprises at least one solvent selected from the group consisting of benzene, toluene, xylene, hexane and cyclohexane.

17. The method according to claim 9, wherein the emulsifier (C) comprises an anionic surfactant.

18. The method according to claim 9, wherein the mechanical emulsification treatment in the emulsification step is one or more selected from the group consisting of pressurized shear agitation treatment, counter impinging treatment, impinging agitation treatment and high speed rotary agitation treatment.

19. The method according to claim 9, wherein the aqueous silicone resin emulsion for preparing a coating composition has an average particle diameter within the range of 100 to 500 nm.

20. The method according to claim 9, wherein:
the branched organopolysiloxane (A1) is a branched organopolysiloxane (A1) having the following structure:
[R¹SiO_{3/2}]ₘ[R²₂SiO]ₙ
wherein R¹ and R² are each independently a hydroxyl group, a linear hydrocarbon group having 1 to 6 carbon atoms, or an aromatic hydrocarbon group having 5 to 7 carbon atoms,
m is 1 to 1,000, n is 1 to 100, and m+n is within a range of 1 to 1,000, and
the linear organopolysiloxane (A2) is a linear organopolysiloxane (A2) having the following structure:
R³—[R⁴₂SiO]ₓ—R⁵
wherein R³ is a hydroxyl group, a linear hydrocarbon group having 1 to 6 carbon atoms, or an aromatic hydrocarbon group having 5 to 7 carbon atoms,
R⁴ is a linear hydrocarbon group having 1 to 6 carbon atoms or an aromatic hydrocarbon group having 5 to 7 carbon atoms,
R⁵ is hydrogen, a linear hydrocarbon group having 1 to 6 carbon atoms, or an aromatic hydrocarbon group having 5 to 7 carbon atoms, and
x is within a range of 1 to 400.

21. The method according to claim 9, wherein in the mixture before the mechanical emulsification treatment containing the silicone resin (A) and the organic solvent (B), a viscosity of the mixture of the silicone resin (A) and the organic solvent (B) is within a range of 10 to 1,500 mPa·s.

22. A method for preparing an aqueous clear coating composition comprising a silicone resin emulsion, comprising the following steps:
an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,
a desolventization step of at least partially removing the organic solvent (B) from the resulting emulsified mixture, thereby obtaining a silicone resin emulsion, and
a step of mixing the resulting silicone resin emulsion and an inorganic oxide fine particle (D), thereby preparing an aqueous clear coating composition,
wherein the silicone resin (A) comprises a branched organopolysiloxane (A1) having a weight average molecular weight within a range of 5,000 to 100,000,
the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water,
a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and a mass ratio (A):(B) of the silicone resin (A) and the organic solvent (B) contained in the emulsified mixture satisfies the relationship of (A):(B)=1:2 to 1:0.2,
the inorganic oxide fine particle (D) has an average particle diameter within a range of 20 to 300 nm.

23. A method for preparing an aqueous clear coating composition comprising a silicone resin emulsion, comprising the following steps:
an emulsification step of subjecting a mixture of a silicone resin (A) and an organic solvent (B) and a mixture of an emulsifier (C) and an aqueous medium to a mechanical emulsification treatment or subjecting a mixture of a silicone resin (A), an organic solvent (B) and an emulsifier (C) and an aqueous medium to a mechanical emulsification treatment, thereby obtaining an emulsified mixture,
a desolventization step of at least partially removing the organic solvent (B) from the resulting emulsified mixture, thereby obtaining a silicone resin emulsion, and
a step of mixing the resulting silicone resin emulsion, an inorganic oxide fine particle (D) and an emulsion prepared in advance and comprising a linear organopolysiloxane (A2) having a weight average molecular weight within a range of 1,000 to 30,000, thereby preparing an aqueous clear coating composition,
wherein the silicone resin (A) comprises a branched organopolysiloxane (A1) having a weight average molecular weight within a range of 5,000 to 100,000, and
a mass ratio of the branched organopolysiloxane (A1) and the linear organopolysiloxane (A2) contained in the aqueous clear coating composition is within a range of (A1):(A2)=98:2 to 40:60,
the organic solvent (B) is an organic solvent which is miscible with the silicone resin (A) in any ratio and has a solubility in water of 1 g/100 g-H₂O or less or a mixture thereof, provided that at least one species of the organic solvent has an azeotropic point with water,
a mass ratio (A):(B) of the silicone resin (A) and the organic solvent (B) in the mixture before the mechanical emulsification treatment comprising the silicone resin (A) and the organic solvent (B) satisfies the relationship of (A):(B)=1:2 to 1:0.2, and a mass ratio (A):(B) of the silicone resin (A) and the organic solvent (B) contained in the emulsified mixture satisfies the relationship of (A):(B)=1:2 to 1:0.2,
the inorganic oxide fine particle (D) has an average particle diameter within a range of 20 to 300 nm.

24. The method according to claim 22, wherein the silicone resin (A) further comprises a linear organopolysiloxane (A2) having a weight average molecular weight within a range of 1,000 to 30,000, and
a mass ratio of the branched organopolysiloxane (A1) and the linear organopolysiloxane (A2) contained in the coating composition is within a range of (A1):(A2)=98:2 to 40:60.

25. The method according to claim 22, wherein the organic solvent (B) comprises at least one solvent selected from the group consisting of benzene, toluene, xylene, hexane and cyclohexane.

26. The method according to claim 22, wherein the emulsifier (C) comprises an anionic surfactant.

27. The method according to claim 22, wherein the mechanical emulsification treatment in the emulsification step is one or more selected from the group consisting of pressurized shear agitation treatment, counter impinging treatment, impinging agitation treatment and high speed rotary agitation treatment.

28. The method according to claim 22, wherein the aqueous silicone resin emulsion for preparing a coating composition has an average particle diameter within the range of 100 to 500 nm.

29. The method according to claim 22, wherein an amount of the inorganic oxide fine particle (D) contained in the aqueous clear coating composition is 3 to 30 parts by mass based on 100 parts by mass of the total resin solid content of the branched organopolysiloxane (A1) and the linear organopolysiloxane (A2).

30. The method according to claim 24, wherein:
the branched organopolysiloxane (A1) is a branched organopolysiloxane (A1) having the following structure:
[R¹SiO_{3/2}]ₘ[R²₂SiO]ₙ
wherein R¹ and R² are each independently a hydroxyl group, a linear hydrocarbon group having 1 to 6 carbon atoms, or an aromatic hydrocarbon group having 5 to 7 carbon atoms,
m is 1 to 1,000, n is 1 to 100, and m+n is within a range of 1 to 1,000, and
the linear organopolysiloxane (A2) is a linear organopolysiloxane (A2) having the following structure:
R³—[R⁴₂SiO]ₓ—R⁵
wherein R³ is a hydroxyl group, a linear hydrocarbon group having 1 to 6 carbon atoms, or an aromatic hydrocarbon group having 5 to 7 carbon atoms,
R⁴ is a linear hydrocarbon group having 1 to 6 carbon atoms or an aromatic hydrocarbon group having 5 to 7 carbon atoms,
R⁵ is hydrogen, a linear hydrocarbon group having 1 to 6 carbon atoms, or an aromatic hydrocarbon group having 5 to 7 carbon atoms, and
x is within a range of 1 to 400.

31. The method according to claim 22, wherein in the mixture before the mechanical emulsification treatment containing the silicone resin (A) and the organic solvent (B), a viscosity of the mixture of the silicone resin (A) and the organic solvent (B) is within a range of 10 to 1,500 mPa·s.

32. The method according to claim 22, wherein the inorganic oxide fine particle (D) comprises at least one selected from the group consisting of silicon oxide, titanium oxide, zinc oxide, tin oxide, cerium oxide, antimony oxide, and their multiple oxide.

33. The method according to claim 22, wherein the inorganic oxide fine particle (D) is a inorganic oxide fine particle obtained by an agitation treatment process involving agitation using medium particles having an average particle diameter of 0.01 to 0.1 mm.

34. The method according to claim 23, wherein the organic solvent (B) comprises at least one solvent selected from the group consisting of benzene, toluene, xylene, hexane and cyclohexane.

35. The method according to claim 23, wherein the emulsifier (C) comprises an anionic surfactant.

36. The method according to claim 23, wherein the mechanical emulsification treatment in the emulsification step is one or more selected from the group consisting of pressurized shear agitation treatment, counter impinging treatment, impinging agitation treatment and high speed rotary agitation treatment.

37. The method according to claim 23, wherein the aqueous silicone resin emulsion for preparing a coating composition has an average particle diameter within the range of 100 to 500 nm.

38. The method according to claim 23, wherein an amount of the inorganic oxide fine particle (D) contained in the aqueous clear coating composition is 3 to 30 parts by mass based on 100 parts by mass of the total resin solid content of the branched organopolysiloxane (A1) and the linear organopolysiloxane (A2).

39. The method according to claim 23, wherein:
the branched organopolysiloxane (A1) is a branched organopolysiloxane (A1) having the following structure:
[R¹SiO_{3/2}]ₘ[R²₂SiO]ₙ
wherein R¹ and R² are each independently a hydroxyl group, a linear hydrocarbon group having 1 to 6 carbon atoms, or an aromatic hydrocarbon group having 5 to 7 carbon atoms,
m is 1 to 1,000, n is 1 to 100, and m+n is within a range of 1 to 1,000, and
the linear organopolysiloxane (A2) is a linear organopolysiloxane (A2) having the following structure:
R³—[R⁴₂SiO]ₓ—R⁵
wherein R³ is a hydroxyl group, a linear hydrocarbon group having 1 to 6 carbon atoms, or an aromatic hydrocarbon group having 5 to 7 carbon atoms,
R⁴ is a linear hydrocarbon group having 1 to 6 carbon atoms or an aromatic hydrocarbon group having 5 to 7 carbon atoms,
R⁵ is hydrogen, a linear hydrocarbon group having 1 to 6 carbon atoms, or an aromatic hydrocarbon group having 5 to 7 carbon atoms, and
x is within a range of 1 to 400.

40. The method according to claim 23, wherein in the mixture before the mechanical emulsification treatment containing the silicone resin (A) and the organic solvent (B), a viscosity of the mixture of the silicone resin (A) and the organic solvent (B) is within a range of 10 to 1,500 mPa·s.

41. The method according to claim 23, wherein the inorganic oxide fine particle (D) comprises at least one selected from the group consisting of silicon oxide, titanium oxide, zinc oxide, tin oxide, cerium oxide, antimony oxide, and their multiple oxide.

42. The method according to claim 23, wherein the inorganic oxide fine particle (D) is a inorganic oxide fine particle obtained by an agitation treatment process involving agitation using medium particles having an average particle diameter of 0.01 to 0.1 mm.
